(19) United States
(12) Patent Application Publication
(10) Pub. No.: US 2026/0110831 A1
(43) Pub. Date: Apr. 23, 2026

(54) OPTICAL FILTER

(71) Applicant: AGC INC., Tokyo (JP)

(72) Inventors: Takashi NAGATA, Haibara-gun (JP); Takahiro SAKAGAMI, Haibara-gun (JP); Kanako OHGUCHI, Haibara-gun (JP); Kazuhiko SHIONO, Koriyama-shi (JP); Kiyokazu ENDO, Koriyama-shi (JP)

(73) Assignee: AGC INC., Tokyo (JP)

(21) Appl. No.: 19/426,519

(22) Filed: Dec. 19, 2025

Related U.S. Application Data
(63) Continuation of application No. PCT/JP2024/023843, filed on Jul. 1, 2024.

(30) Foreign Application Priority Data
Jul. 4, 2023 (JP) 2023-109750

(51) Int. Cl. G02B 5/28; G02B 5/20; H04N 23/52

(52) U.S. Cl. CPC G02B 5/282; G02B 5/208; H04N 23/52

(57) ABSTRACT

Provided is an optical filter in which a first barrier layer, a first multilayer film, and a resin layer are provided on a first main surface of a glass substrate, a second barrier layer and a second multilayer film are provided on a second main surface of the glass substrate, a third multilayer film is disposed on the resin layer, the glass substrate is fluorophosphate glass containing an infrared absorbent, and the first barrier layer and the second barrier layer each independently contain an oxide of at least one metal selected from the group consisting of Al, Ti, Nb, Ta, and Hf at a ratio of 80 mol % or more.

### CROSS-REFERENCE TO RELATED APPLICATIONS

This application is a continuation application of International Application No. PCT/JP2024/023843 filed Jul. 1, 2024 the disclosure of which is incorporated herein by reference in its entirety. Further, this application claims priorities from Japanese Patent Application No. 2023-109750 filed Jul. 4, 2023, the disclosure of which is incorporated herein by reference in their entirety.

### TECHNICAL FIELD

The present invention relates to an optical filter.

### BACKGROUND ART

Image pickup devices such as in-vehicle cameras and smartphone cameras include a solid state image sensor (such as a CCD or a CMOS). The solid state image sensor exhibits greater sensitivity to infrared light than human visual sense. Therefore, in order to bring images by the solid state image sensor closer to human visual sensitivity, an optical filter is further installed on the image pickup device.

A high-precision optical filter is required to (1) have a high transmittance in a visible light region, (2) have high light shielding properties in an infrared region, and (3) have optical characteristics that do not change depending on an incident angle of light.

In this regard, Patent Literature 1 (PCT International Publication No. WO2014/030628) describes an optical filter having a CuO-containing fluorophosphate glass substrate. The CuO-containing fluorophosphate glass substrate has a function of absorbing infrared rays to some extent. Therefore, it is disclosed that an optical filter having the effects of (1) to (3) described above can be provided by combining a CuO-containing fluorophosphate glass substrate, a dye-containing layer, and an infrared reflecting film.

However, according to the inventors of the present application, it is understood that the effects of (2) and (3) described above are also insufficient in the optical filter described in Patent Literature 1.

Meanwhile, Patent Literature 2 (PCT International Publication No. WO2023/282187) describes an optical filter in which, as a glass substrate, phosphate glass is applied instead of fluorophosphate glass. CuO-containing phosphate glass has a higher infrared absorption function than CuO-containing fluorophosphate glass. Therefore, it is disclosed that a filter having a significantly high light shielding properties in an infrared region can be obtained by using such a phosphate glass substrate.

However, according to the inventors of the application, the phosphate glass has a problem in that elution is likely to occur when coming into contact with moisture. Therefore, in the optical filter in which the phosphate glass is applied as a glass substrate, a problem may arise in which the glass substrate is deteriorated over time, and thus filter characteristics are deteriorated.

### SUMMARY

The invention has been made in view of such a background, and an object of the invention is to provide an optical filter having significantly high light shielding properties in an infrared region and significantly improved water resistance.

In the invention, provided is an optical filter including: a glass substrate,
in which the glass substrate has a first main surface and a second main surface opposite to each other;
a first barrier layer, a first multilayer film, and a resin layer are disposed on the first main surface of the glass substrate in this order from the glass substrate side;
a second barrier layer and a second multilayer film are disposed on the second main surface of the glass substrate in this order from the glass substrate side;
a third multilayer film is disposed on the resin layer;
the glass substrate is fluorophosphate glass containing an infrared absorbent;
the first barrier layer and the second barrier layer each independently contain an oxide of at least one metal selected from the group consisting of aluminum (Al), titanium (Ti), niobium (Nb), tantalum (Ta), and hafnium (Hf) at a ratio of 80 mol % or more,
the resin layer contains a near infrared absorbing dye having a maximum absorption wavelength in a range of from 700 nm to 800 nm,
the first multilayer film, the second multilayer film, and the third multilayer film each independently include a plurality of dielectric layers, and
the optical filter has spectral characteristics in which
when light is incident from a side of the second multilayer film,
(I) an average transmittance Tₜ₍₁₎ₐᵥₑ₁ at a wavelength of from 900 nm to 1,200 nm is 5% or less at an incident angle θ=0°, and an average transmittance Tₜ₍₁₎ₐᵥₑ₂ at a wavelength of from 900 nm to 1,200 nm is 5% or less at an incident angle α=60°.

In the invention, it is possible to provide an optical filter having significantly high light shielding properties in an infrared region and having significantly improved water resistance.

### BRIEF DESCRIPTION OF DRAWINGS

FIG. 1 is a cross-sectional view schematically showing a configuration example of an optical filter according to one embodiment of the invention.

FIG. 2 is a flowchart schematically showing an example of a method of manufacturing the optical filter according to one embodiment of the invention.

FIG. 3 is a diagram showing an example of optical characteristics of a glass substrate included in the optical filter according to one embodiment of the invention, compared to optical characteristics of a conventional glass substrate.

FIG. 4 is a graph showing an example of optical characteristics (transmittance) of the optical filter according to one embodiment of the invention.

FIG. 5 is a graph showing an example of optical characteristics (reflectance measured on the third multilayer film side) of the optical filter according to one embodiment of the invention.

FIG. 6 is a graph showing an example of optical characteristics (reflectance measured on the second multilayer film side) of the optical filter according to one embodiment of the invention.

### DETAILED DESCRIPTION

Hereinafter, one embodiment of the invention will be described with reference to the drawings.

As described above, an optical filter using a conventional fluorophosphate glass substrate has a problem in that the effects of (2) and (3) described above are still insufficient. In addition, in an optical filter in which phosphate glass is applied as a substrate instead of fluorophosphate glass, a problem may arise in terms of environmental resistance since the glass substrate has low resistance to moisture.

The inventors of the application have conducted intensive studies under such circumstances, and found an optical filter having significantly high light shielding properties in an infrared region and having significantly improved water resistance.

That is, in one embodiment of the invention, there is provided an optical filter including: a glass substrate,
in which the glass substrate has a first main surface and a second main surface opposite to each other;
a first barrier layer, a first multilayer film, and a resin layer are disposed on the first main surface of the glass substrate in this order from the glass substrate side;
a second barrier layer and a second multilayer film are disposed on the second main surface of the glass substrate in this order from the glass substrate side;
a third multilayer film is disposed on the resin layer;
the glass substrate is fluorophosphate glass containing an infrared absorbent;
the first barrier layer and the second barrier layer each independently contain an oxide of at least one metal selected from the group consisting of aluminum (Al), titanium (Ti), niobium (Nb), tantalum (Ta), and hafnium (Hf) at a ratio of 80 mol % or more,
the resin layer contains a near infrared absorbing dye having a maximum absorption wavelength in a range of from 700 nm to 800 nm,
the first multilayer film, the second multilayer film, and the third multilayer film each independently include a plurality of dielectric layers, and
the optical filter has spectral characteristics in which
when light is incident from a side of the second multilayer film,
(I) an average transmittance Tₜ₍₁₎ₐᵥₑ₁ at a wavelength of from 900 nm to 1,200 nm is 5% or less at an incident angle θ=0°, and an average transmittance Tₜ₍₁₎ₐᵥₑ₂ at a wavelength of from 900 nm to 1,200 nm is 5% or less at an incident angle θ=60°.

In the optical filter according to one embodiment of the invention, fluorophosphate glass containing an infrared absorbent is used as the glass substrate.

The fluorophosphate glass has significantly higher infrared absorption characteristics than conventional fluorophosphate glass. Therefore, with the optical filter according to one embodiment of the invention, it is possible to provide an optical filter having significantly higher light shielding properties in an infrared region than conventional optical filters using fluorophosphate glass for a glass substrate.

In addition, the fluorophosphate glass used in one embodiment of the invention has lower resistance to moisture than conventional fluorophosphate glass, and tends to undergo elution relatively easily.

However, in one embodiment of the invention, a stacked structure of a barrier layer and a multilayer film is disposed on each main surface of the glass substrate.

That is, the first barrier layer and the first multilayer film are disposed on the first main surface of the glass substrate, and the second barrier layer and the second multilayer film are disposed on the second main surface of the glass substrate. In addition, the first barrier layer and the second barrier layer each contain an oxide of at least one metal selected from the group consisting of aluminum (Al), titanium (Ti), niobium (Nb), tantalum (Ta), and hafnium (Hf) at a ratio of 80 mol % or more. Furthermore, each of the first multilayer film and the second multilayer film includes a dielectric multilayer film.

As described above, each main surface of the glass substrate is coated with a combination of the barrier layer and the multilayer film, and thus exposure of the glass substrate to the outside is suppressed. As a result, in the optical filter according to one embodiment of the invention, it is possible to significantly suppress the problem of elution from the glass substrate.

Due to the above-described effects, in one embodiment of the invention, it is possible to provide an optical filter having a significantly high light shielding properties in an infrared region and exhibiting stable characteristics over a long period of time.

In one embodiment of the invention, the first main surface and the second main surface of the glass substrate are coated with the first barrier layer and the first multilayer film, and with the second barrier layer and the second multilayer film, respectively. In contrast, it is not always necessary to arrange such a layer configuration on an end surface of the glass substrate.

This is because the ratio of the end surface to the total surface area of the glass substrate is sufficiently low, and the problem of glass elution can be suppressed in a case in which the main surfaces occupying the majority of the surface area of the glass substrate are coated with the above-described configuration.

### (Optical Filter According to One Embodiment of Invention)

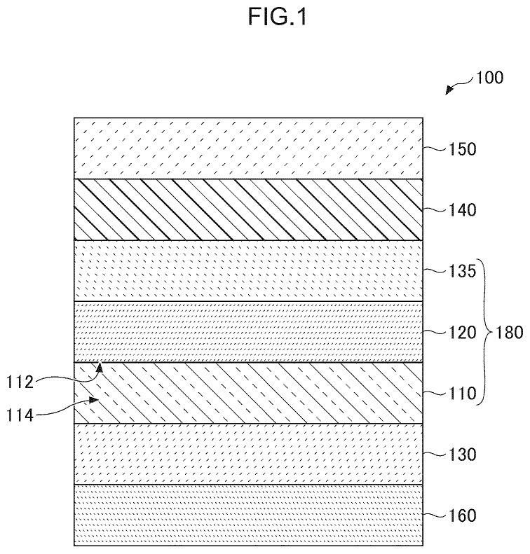

Hereinafter, the optical filter according to one embodiment of the invention will be described in greater detail with reference to FIG. 1.

FIG. 1 schematically shows a cross section of a configuration of the optical filter according to one embodiment of the invention.

As shown in FIG. 1, the optical filter (hereinafter, referred to as “first optical filter”) 100 according to one embodiment of the invention has a glass substrate 110 having a first main surface 112 and a second main surface 114 opposed to each other.

The glass substrate 110 is made of fluorophosphate glass containing an infrared absorbent.

A first barrier layer 120, a first multilayer film 135, a resin layer 140, and a third multilayer film 150 are disposed on the first main surface 112 side of the glass substrate 110 in this order from the glass substrate 110 side. In addition, a second barrier layer 130 and a second multilayer film 160 are disposed on the second main surface 114 side of the glass substrate 110 in this order from the glass substrate 110 side.

Each of the first multilayer film 135, the second multilayer film 160, and the third multilayer film 150 includes a plurality of dielectric layers. Specifically, the first multilayer film 135, the second multilayer film 160, and the third multilayer film 150 are configured as a stack in which high refractive index layers and low refractive index layers are alternately stacked.

The resin layer 140 has a near infrared absorbing dye having a maximum absorption wavelength in a range of from 700 nm to 800 nm.

The first barrier layer 120 and the second barrier layer 130 each independently contain an oxide of at least one metal selected from the group consisting of aluminum (Al), titanium (Ti), niobium (Nb), tantalum (Ta), and hafnium (Hf) at a ratio of 80 mol % or more.

As described above, a glass substrate made of phosphate glass tends to undergo elution relatively easily when coming into contact with moisture in the environment.

However, in the first optical filter 100, the glass substrate 110 is made of fluorophosphate glass. Therefore, in the first optical filter 100, it is possible to suppress the elution from the glass substrate to some extent as compared to conventional optical filters using phosphate glass for a glass substrate.

In addition, in the first optical filter 100, the first main surface 112 of the glass substrate 110 is protected with the first barrier layer 120 and the first multilayer film 135, and the second main surface 114 is protected with the second barrier layer 130 and the second multilayer film 160. Therefore, in the first optical filter 100, it is possible to further suppress the elution from the glass substrate 110.

Furthermore, as will be described in detail later, new fluorophosphate glass having a high infrared absorption effect is used for the glass substrate 110, unlike conventional fluorophosphate glass.

Due to the above-described effect, the first optical filter 100 has significantly high light shielding properties in an infrared region, and can exhibit stable characteristics over a long period of time.

### (Members Included in Optical Filter According to One Embodiment of Invention)

Next, the members included in the optical filter according to one embodiment of the invention will be described in greater detail. Here, for the sake of clarity, the components of the first optical filter 100 shown in FIG. 1 will be described as an example. Therefore, the reference numerals shown in FIG. 1 are used to represent the respective members.

### (First Barrier Layer 120 and Second Barrier Layer 130)

As described above, the first barrier layer 120 and the second barrier layer 130 contain an oxide of at least one metal selected from the group consisting of aluminum (Al), titanium (Ti), niobium (Nb), tantalum (Ta), and hafnium (Hf) in an amount of 80 mol % or more, preferably 90 mol % or more, more preferably 95 mol % or more, and particularly preferably 100 mol %.

Oxides of metals of aluminum (Al), titanium (Ti), niobium (Nb), tantalum (Ta), and hafnium (Hf) all have high resistance to moisture, and by protecting the first main surface 112 and the second main surface 114 of the glass substrate 110 with the above material, it is possible to suppress the intrusion of moisture into the main surfaces of the glass substrate 110, so that it is possible to suppress the elution from the glass substrate 110.

For example, a resin material is not preferable as the material of the first barrier layer 120 and the second barrier layer 130 from the viewpoint that the resin material has lower moisture intrusion suppression properties than inorganic materials.

In addition, from the viewpoint of improving adhesion between the glass substrate 110 and the first multilayer film, the first barrier layer 120 preferably contains an oxide of at least one metal selected from the group consisting of aluminum (Al), titanium (Ti), niobium (Nb), tantalum (Ta), and hafnium (Hf) in an amount of 80 mol % or more. The second barrier layer 130 preferably similarly satisfies the above-described requirement from the viewpoint of improving adhesion between the glass substrate 110 and the second multilayer film.

Here, in the first barrier layer 120 and the second barrier layer 130, an oxide of at least one metal selected from the group consisting of aluminum (Al), titanium (Ti), niobium (Nb), tantalum (Ta), and hafnium (Hf) may be contained alone in an amount of 80 mol % or more, or two or more materials may be contained in an amount of 80 mol % or more in total.

In addition, the first barrier layer 120 and the second barrier layer 130 may satisfy the above-described requirement and contain a material other than the oxides of metals aluminum (Al), titanium (Ti), niobium (Nb), tantalum (Ta), and hafnium (Hf) as long as resistance to moisture is not impaired. For example, from the viewpoint of adjusting the refractive indices of the first barrier layer 120 and the second barrier layer 130, an oxide of silicon (Si) may be contained. Since a layer containing silicon (Si) may reduce the adhesion to the glass substrate, it is preferable that silicon (Si) is not contained as much as possible. In addition, from the viewpoint of increasing the water resistance of the optical filter, it is preferable that a material other than the oxides of metals aluminum (Al), titanium (Ti), niobium (Nb), tantalum (Ta), and hafnium (Hf) is not contained.

The first barrier layer 120 is installed to increase the water resistance of the glass substrate 110 in cooperation with the first multilayer film 135. That is, the glass substrate 110 made of fluorophosphate glass having the above-described composition has better water resistance than phosphate glass, but tends to have poorer water resistance than conventional fluorophosphate glass. However, by coating the first main surface 112 of the glass substrate 110 with the first barrier layer 120 and the first multilayer film 135, it is possible to sufficiently suppress the elution from the glass substrate 110.

The same also applies to a set of the second barrier layer 130 and the second multilayer film 160.

The first barrier layer 120 and the second barrier layer 130 do not necessarily have to be made of the same material.

The first barrier layer 120 and the second barrier layer 130 may be made of the same material. In particular, the first barrier layer 120 and the second barrier layer 130 are preferably made of an aluminum oxide or a titanium oxide. This is because these barrier films serve as effective protective barriers against moisture.

The method of forming the first barrier layer 120 and the second barrier layer 130 is not particularly limited. The first barrier layer 120 and the second barrier layer 130 may be formed by, for example, a sputtering method, a vapor deposition method, or the like.

The thicknesses of the first barrier layer 120 and the second barrier layer 130 are not particularly limited. The thickness of each of the first barrier layer 120 and the second barrier layer 130 may be, for example, in a range of from 0.1 μm to 1 μm.

### (First Multilayer Film 135)

As described above, the first multilayer film 135 is configured as a stack in which high refractive index layers and low refractive index layers are alternately stacked.

Among the layers, the high refractive index layer may be selected from titania and alumina, for example. The low refractive index layer may be selected from silica and magnesium fluoride, for example.

The total thickness of the first multilayer film 135 is, for example, in a range of from 0.1 μm to 3 μm, but is not limited thereto.

The first multilayer film 135 has a role of protecting the glass substrate 110 from the outside and adjusting the optical characteristics of the first optical filter 100 in cooperation with the first barrier layer 120.

Here, in a portion (hereinafter, also referred to as “stacked portion”) 180 ranging from the first barrier layer 120 to the first multilayer film 135, X expressed by the following Expression (1):

$$X ( \% ) = \{ A / ( B - C ) \} \times 100 \qquad Expression ( 1 )$$

may be 35% or more. X (%) is more preferably 50% or more, and still more preferably 70% or more.

In Expression (1), A (nm) represents a total thickness of dielectric layers included in the stacked portion 180 and having a QWOT of less than 2 and a refractive index of 1.9 or less when the layers included in the stacked portion 180 are evaluated by QWOT expressed by the following Expression (2):

$$QWOT = ( thickness of target layer / 550 nm ) \times 4 \times refractive index at wavelength of 550 nm , \qquad Expression ( 2 )$$

B (nm) represents a total thickness of the stacked portion 180, and
C (nm) represents a total thickness of layers having a QWOT of 2 or more in the stacked portion 180.

In a case in which the stacked portion 180 is configured as described above, it is possible to significantly suppress the influence of unfavorable reflection behavior at an interface between the first barrier layer 120 and the resin layer 140.

By suppressing the above-described reflection behavior, for example, an optical filter having an improved visible light transmittance and better spectral characteristics can be obtained.

In addition, from the viewpoint of improving the water resistance of the optical filter, the stacked portion 180 preferably has a thickness of 0.2 μm or more, more preferably 0.5 μm or more, still more preferably 1.0 μm or more, and even more preferably 2.0 μm or more.

Meanwhile, from the viewpoint of relaxing the stress and suppressing the peeling from the glass substrate 110, the stacked portion 180 preferably has a thickness of 5 m or less, and more preferably 3 m or less. The thickness of the stacked portion 180 can be selected according to desired characteristics of the optical filter.

In a case in which the stacked portion 180 has a layer made of SiO₂, in the stacked portion 180, X′ expressed by the following Expression (3):

$${X}^{′} ( \% ) = \{ {A}^{′} / ( {B}^{′} - {C}^{′} ) \} \times 100 \qquad Expression ( 3 )$$

may be 35% or more. X (%) is more preferably 50% or more, and still more preferably 70% or more.

In Expression (3),
A′ (nm) represents a total thickness of the SiO₂ layers having a thickness of 180 nm or less in the stacked portion 180,
B′ (nm) represents a total thickness of the stacked portion 180, and
C′ (nm) represents a total thickness of the SiO₂ layers having a thickness more than 180 nm in the stacked portion 180.

### (Second Multilayer Film 160)

As described above, the second multilayer film 160 is configured as a stack in which high refractive index layers and low refractive index layers are alternately stacked.

Among the layers, the high refractive index layer may be selected from titania and alumina, for example. The low refractive index layer may be selected from silica and magnesium fluoride, for example.

The total thickness of the second multilayer film 160 is, for example, in a range of from 0.1 m to 3 μm, but is not limited thereto.

The second multilayer film 160 has a role of protecting the glass substrate 110 from the outside and adjusting the optical characteristics of the first optical filter 100 in cooperation with the second barrier layer 130.

For example, the second multilayer film 160 may function as an “infrared reflecting film”.

In the application, the “infrared reflecting film” means a layer configured to have a wavelength band with a width of 100 nm or more in which the reflectance is 80% or more for light having a wavelength between 750 nm and 1,200 nm at an incident angle θ=5°.

In addition, in the first optical filter 100, in a case in which the second multilayer film 160 is stacked as an “infrared reflecting film”, the second multilayer film 160 is preferably designed to gently reflect infrared rays in order to suppress a change in optical characteristics of the first optical filter 100 due to the incident angle of the light.

Specifically, the second multilayer film 160 is preferably designed to have spectral characteristics in which, when light is incident on the first optical filter 100 from the second multilayer film side, an average reflectance in a wavelength range of from 800 nm to 1,200 nm is 50% or more and 90% or less at an incident angle θ=5°.

### (Third Multilayer Film 150)

As described above, the third multilayer film 150 is configured as a stack in which high refractive index layers and low refractive index layers are alternately stacked.

Among the layers, the high refractive index layer may be selected from titania and alumina, for example. The low refractive index layer may be selected from silica and magnesium fluoride, for example.

The total thickness of the third multilayer film 150 is, for example, in a range of from 0.1 μm to 3 μm, but is not limited thereto.

The third multilayer film 150 has a role of adjusting the optical characteristics of the first optical filter 100.

For example, the third multilayer film 150 may function as an “antireflection film”.

In the application, the “antireflection film” means a layer configured to have a maximum reflectance of 45% or less with respect to light having a wavelength between 450 nm and 1,200 nm.

### (Glass Substrate 110)

Hereinafter, the glass substrate 110 used for the optical filter according to one embodiment of the invention will be described. In the following description, unless otherwise specified, the content of each component and the total content are expressed by mass %.

The glass substrate 110 is made of fluorophosphate glass containing an infrared absorbent. In the application, the “fluorophosphate glass” refers to glass containing 20% or more of P⁵⁺ by mass % and containing 3% or more of F⁻, expressed on an external ratio basis. The infrared absorbent is preferably Cu²⁺ from the viewpoint of obtaining excellent infrared absorbing ability, but other components may be used.

For example, the glass substrate 110 may contain, by mass %,
P⁵⁺: from 20% to 70%,
Al³⁺: from 1% to 20%,
K⁺: from 0% to 40%,
Li⁺: from 0% to 30%,
Na⁺: from 0% to 40%,
Rb⁺: from 0% to 20%,
Cs⁺: from 0% to 20%,
ΣR⁺ (R⁺ represents one or more components selected from Li⁺, Na⁺, Rb⁺, and Cs⁺, and ΣR⁺ represents a total amount of R⁺)+K⁺: from 1% to 50%,
Mg²⁺: from 0% to 20%,
Ca²⁺: from 0% to 20%,
Sr²⁺: from 0% to 30%,
Ba²⁺: from 0% to 30%,
Cu²⁺: from 1% to 20%,
Zn²⁺: from 0% to 20%, and
ΣR″²⁺ (R″²⁺ represents one or more components selected from Ba²⁺, Sr²⁺, Ca²⁺, and Mg²⁺, and ΣR″²⁺ represents a total amount of R″²⁺): from 1% to 50%, and may contain from 3% to 60% of F⁻, expressed on an external ratio basis.

In addition, the glass substrate 110 more preferably has the following composition from the viewpoint of further increasing the infrared absorption characteristics.

The glass substrate contains, by mass %,
P⁵⁺: from 20% to 70%,
Al³⁺: from 3.5% to 20%,
K⁺: from 1% to 40%,
Li⁺: from 0% to 30%,
Na⁺: from 0% to 40%,
Rb⁺: from 0% to 20%,
Cs⁺: from 0% to 20%,
ΣR⁺ (R⁺ represents one or more components selected from Li⁺, Na⁺, Rb⁺, and Cs⁺, and ΣR⁺ represents a total amount of R⁺)+K⁺: from 13% to 40%,
Mg²⁺: from 0% to 20%,
Ca²⁺: from 0% to 20%,
Sr²⁺: from 0% to 30%,
Ba²⁺: from 0% to 30%,
Cu²⁺: from 1% to 20%,
Zn²⁺: from 0% to 20%, and
ΣR″²⁺ (R″²⁺ represents one or more components selected from Ba²⁺, Sr²⁺, Ca²⁺, and Mg²⁺, and ΣR″²⁺ represents a total amount of R″²⁺): from 14% to 35%,
and contains from 3% to 60% of F⁻, expressed on an external ratio basis.

The components that can be included in the glass substrate 110 and suitable contents thereof will be described below.

In the glass substrate 110, phosphorus (P) is contained as P⁵⁺. P⁵⁺ is a main component that forms fluorophosphate glass, and is an essential component for increasing the sharp cutting properties in a near infrared region. The content of P⁵⁺ is preferably from 20% to 70%. In a case in which the content of P⁵⁺ is 20% or more, the effects of P⁵⁺ can be sufficiently obtained, and in a case in which the content of P⁵⁺ is 70% or less, problems such as the glass becoming unstable and a decrease in weather resistance rarely occur. Therefore, the content of P⁵⁺ is more preferably 25% or more, still more preferably 30% or more, even more preferably 33% or more, and most preferably 35% or more. The content of P⁵⁺ is more preferably 60% or less, still more preferably 55% or less, even more preferably 50% or less, and most preferably 45% or less. As a raw material of P⁵⁺, a phosphoric acid or a salt thereof is preferably used from the viewpoint of suppressing the erosion of the platinum crucible and suppressing the volatilization of the components.

In the glass substrate 110, fluorine (F) is contained as F⁻. F⁻ is an essential component for stabilizing glass and improving weather resistance. In the present specification, the content of F⁻ contained in the glass is expressed on an external ratio basis when the content of the component elements other than F⁻ contained in the glass is set to 100 mass %. The content of F⁻ is preferably from 3% to 60% expressed on an external ratio basis.

In a case in which the content of F⁻ is 3% or more expressed on an external ratio basis, the effect of weather resistance can be sufficiently obtained, and in a case in which the content of F⁻ is 60% or less expressed on an external ratio basis, problems such as a decrease in light transmittance in a visible region and in light absorbing ability and sharp cutting properties in a near infrared region, a decrease in mechanical characteristics such as strength, hardness, and elastic modulus, and an increase in ultraviolet transmittance rarely occur. The content of F⁻ is more preferably 4% or more expressed on an external ratio basis, still more preferably 6% or more expressed on an external ratio basis, even more preferably 8% or more expressed on an external ratio basis, and most preferably 10% or more expressed on an external ratio basis. The content of F⁻ is more preferably 50% or less expressed on an external ratio basis, still more preferably 40% or less expressed on an external ratio basis, even more preferably 30% or less expressed on an external ratio basis, and most preferably 20% or less expressed on an external ratio basis.

In the glass substrate 110, copper (Cu) is contained as Cu⁺ or Cu²⁺, but the specification describes the content of Cu as if all Cu were present in the Cu²⁺ state.

Cu²⁺ is a component for improving the absorbing ability in a near infrared region. In addition, since Cu²⁺ has properties of forming a bridged structure by attracting phosphate chains in the glass, the glass structure is strengthened, and the weather resistance and the strength of the glass are improved. The content of Cu²⁺ is preferably from 1% to 20%. In a case in which the content of Cu²⁺ is less than 1%, there is a concern that the absorbing ability of the glass in a near infrared region may decrease. The content of Cu²⁺ is preferably 2% or more, more preferably 3% or more, still more preferably 4% or more, and even more preferably 5% or more. In addition, in a case in which the content of Cu²⁺ is more than 20%, the glass is likely to be unstable, and the risk of devitrification increases. The content of Cu²⁺ is preferably 18% or less, more preferably 14% or less, still more preferably 12% or less, and even more preferably 10% or less.

In addition, the total Cu amount is a total amount of Cu expressed by mass %, including monovalent, divalent, and other existing valences, and in a case in which the content (excluding, however, the content of F⁻) of all the components of the glass substrate 110 is set to 100%, the range of the total Cu content in the glass is preferably from 1% to 20%. In a case in which the total Cu amount is 1% or more, the effect of absorbing ability in a near infrared region can be sufficiently obtained, and in a case in which the total Cu amount is 20% or less, a decrease in transmittance in a visible region can be suppressed. The content of Cu⁺ expressed by % can be determined in such a range that (Cu⁺/total Cu amount)×100 [%] is from 0.01% to 4.0%.

In the glass substrate 110, aluminum (Al) is contained as Al³⁺. Al³⁺ is a component that forms glass, and is a component for increasing the strength of the glass, the weather resistance of the glass, and the like. In a case in which the content of Al³ is 1% or more, the effects of Al³ can be sufficiently obtained, and in a case in which the content of Al³⁺ is 20% or less, problems such as the glass becoming unstable and a decrease in absorbing ability and sharp cutting properties in a near infrared region rarely occur. The content of Al³⁺ is preferably from 1% to 20%. The content of Al³⁺ is more preferably 2% or more, still more preferably 3% or more, even more preferably 4% or more, and most preferably 5% or more. The content of Al³⁺ is more preferably 19% or less, still more preferably 18% or less, even more preferably 15% or less, and most preferably 13% or less.

As a raw material of Al³⁺, AlF₃, Al₂O₃, Al(OH)₃, and the like can be used, and among these, AlF₃ is preferably used since problems such as an increase in dissolution temperature, the generation of unmelted matter, and the glass becoming unstable due to a decrease in amount of F⁻ charged rarely occur.

Lithium (Li) is a component for lowering the melting temperature of glass, lowering the liquid phase temperature of glass, improving the weather resistance of glass, stabilizing glass, and the like. The content of Li⁺ is preferably from 0% to 30%. In a case in which the content of Li⁺ is 30% or less, the glass is unlikely to be unstable. In a case in which Li is contained, the absorbing ability and the sharp cutting properties in a near infrared region decrease, and thus the content of Li⁺ is more preferably 28% or less, still more preferably 25% or less, even more preferably 20% or less, and most preferably 10% or less. The content of Li⁺ is more preferably 0.5% or more, still more preferably 1% or more, and even more preferably 3% or more. In a case in which the alkali metal component is only Li⁺, the weather resistance is improved, but the absorbing ability and the sharp cutting properties in a near infrared region decrease. Accordingly, it is necessary to further contain one or more alkali metal components having a larger ionic radius than Li⁺.

Sodium (Na) is a component for lowering the melting temperature of glass, lowering the liquid phase temperature of glass, stabilizing glass, and the like. The content of Na⁺ is preferably from 0% to 40%. In a case in which the content of Na⁺ is 40% or less, the glass is unlikely to be unstable. The content of Na⁺ is more preferably 30% or less, still more preferably 25% or less, even more preferably 20% or less, and most preferably 10% or less. The content of Na⁺ is more preferably 0.5% or more, still more preferably 1% or more, and even more preferably 3% or more. In a case in which the alkali metal component is only Na⁺, either improved weather resistance or high absorbing ability and improved sharp cutting properties in a near infrared region can be obtained, and the characteristics to be improved differ depending on the composition system. However, it is difficult to improve both the characteristics at the same time. Therefore, it is necessary to contain one or more alkali metal components other than Na⁺ in order to improve the weather resistance, and to contain an alkali metal component having a larger ionic radius than Na⁺ in order to improve the absorbing ability and the sharp cutting properties in a near infrared region.

In the glass substrate 110, potassium (K) is contained as K⁺. K⁺ is an effective component to lower the melting temperature of glass, lower the liquid phase temperature of glass, improve the absorbing ability and the sharp cutting properties in a near infrared region, and the like. The content of K⁺ is preferably from 0% to 40%. In a case in which the content of K⁺ is 40% or less, the glass is unlikely to be unstable, which is preferable. The content of K⁺ is more preferably 0.5% or more, still more preferably 1% or more, even more preferably 3% or more, and most preferably 5% or more. In a case in which K⁺ is contained, the weather resistance decreases, and thus the content of K⁺ is preferably 30% or less, more preferably 25% or less, still more preferably 20% or less, and most preferably 14% or less. In a case in which the alkali metal component is only K⁺, the absorbing ability and the sharp cutting properties in a near infrared region are improved, but the weather resistance decreases. Therefore, it is necessary to contain one or more alkali metal components other than K⁺ in order to improve the weather resistance by the alkali mixing effect.

Rubidium (Rb) is an effective component to lower the melting temperature of glass, lower the liquid phase temperature of glass, improve the absorbing ability and the sharp cutting properties in a near infrared region, and the like. The content of Rb⁺ is preferably from 0% to 20%. In a case in which the content of Rb⁺ is 20% or less, the glass is unlikely to be unstable, which is preferable. In a case in which Rb⁺ is contained, the weather resistance decreases, and thus the content of Rb⁺ is more preferably 15% or less, still more preferably 10% or less, and even more preferably 5% or less. The content of Rb⁺ is more preferably 0.5% or more, still more preferably 1% or more, and even more preferably 3% or more. In a case in which the alkali metal component is only Rb⁺, the absorbing ability and the sharp cutting properties in a near infrared region are improved, but the weather resistance decreases. Therefore, it is necessary to contain one or more alkali metal components other than Rb⁺ in order to improve the weather resistance by the alkali mixing effect.

Cesium (Cs) is an effective component to lower the melting temperature of glass, lower the liquid phase temperature of glass, achieve high absorbing ability in a near infrared region, improve the sharp cutting properties, and the like. The content of Cs⁺ is preferably from 0% to 20%. In a case in which the content of Cs is 20% or less, the glass is unlikely to be unstable, which is preferable. In a case in which Cs⁺ is contained, the weather resistance decreases, and thus the content of Cs⁺ is more preferably 15% or less, still more preferably 10% or less, and even more preferably 5% or less. The content of Cs⁺ is more preferably 0.5% or more, still more preferably 1% or more, and even more preferably 3% or more. In a case in which the alkali metal component is only Cs⁺, the absorbing ability and the sharp cutting properties in a near infrared region are improved, but the weather resistance decreases. Therefore, it is necessary to contain one or more alkali metal components other than Cs⁺ in order to improve the weather resistance by the alkali mixing effect.

K⁺ and R⁺ (R⁺ represents one or more selected from Li⁺, Na⁺, Rb⁺, and Cs⁺) are components for lowering the melting temperature of glass, lowering the liquid phase temperature of glass, stabilizing glass, and the like. In a case in which the total amount of R⁺ and K⁺, that is, the total amount (ΣR⁺+K⁺) of Li⁺, Na⁺, K⁺, Rb⁺, and Cs⁺ is 1% or more, the effects thereof can be sufficiently obtained, and in a case in which the total amount is 50% or less, the glass is unlikely to be unstable, which is preferable. Therefore, the content of ΣR⁺+K⁺ is preferably from 1% to 50%. The content of ΣR⁺+K⁺ is more preferably 5% or more, still more preferably 10% or more, even more preferably 12% or more, and most preferably 15% or more. The content of ΣR⁺+K⁺ is more preferably 45% or less, still more preferably 40% or less, even more preferably 30% or less, and most preferably 28% or less.

Magnesium (Mg) is a component for lowering the melting temperature of glass, lowering the liquid phase temperature of glass, stabilizing glass, increasing the strength of glass, increasing the weather resistance of glass, and the like. The content of Mg²⁺ is preferably from 0% to 20%. In a case in which the content of Mg²⁺ is 20% or less, problems such as the glass becoming unstable and a decrease in near infrared ray cutting properties rarely occur. The content of Mg²⁺ is more preferably 15% or less, still more preferably 10% or less, and even more preferably 5% or less.

Calcium (Ca) is a component for lowering the melting temperature of glass, lowering the liquid phase temperature of glass, stabilizing glass, increasing the strength of glass, increasing the weather resistance of glass, and the like. The content of Ca²⁺ is preferably from 0% to 20%. In a case in which the content of Ca²⁺ is 20% or less, problems such as the glass becoming unstable and a decrease in near infrared ray cutting properties rarely occur. The content of Ca²⁺ is more preferably 1% or more, and still more preferably 2% or more. The content of Ca²⁺ is more preferably 18% or less, still more preferably 15% or less, even more preferably 10% or less, and most preferably 7% or less.

Strontium (Sr) is a component for lowering the melting temperature of glass, lowering the liquid phase temperature of glass, stabilizing glass, increasing the strength of glass, increasing the weather resistance of glass, and the like. The content of Sr²⁺ is preferably from 0% to 30%. In a case in which the content of Sr²⁺ is 30% or less, problems such as the glass becoming unstable and a decrease in near infrared ray cutting properties rarely occur. The content of Sr²⁺ is more preferably 1% or more, still more preferably 2% or more, even more preferably 4% or more, and most preferably 5% or more. The content of Sr²⁺ is more preferably 25% or less, still more preferably 20% or less, even more preferably 16% or less, and most preferably 14% or less.

Barium (Ba) is a component for lowering the melting temperature of glass, lowering the liquid phase temperature of glass, stabilizing glass, increasing the light absorbing ability in a near infrared region, increasing the sharp cutting properties in a near infrared region, and the like. The content of Ba²⁺ is preferably from 0% to 40%. In a case in which the content of Ba²⁺ is 40% or less, problems such as the glass becoming unstable rarely occur. The content of Ba²⁺ is more preferably 1% or more, still more preferably 5% or more, and even more preferably 10% or more. The content of Ba²⁺ is more preferably 35% or less, still more preferably 30% or less, and even more preferably 20% or less.

R″2+ (R″2+ represents one or more components selected from Mg²⁺, Ca²⁺, Sr²⁺, and Ba²⁺) is a component for lowering the melting temperature of glass, lowering the liquid phase temperature of glass, stabilizing glass, and the like. In a case in which the total amount of R″2+, that is, the total amount (ΣR″²⁺) of Mg²⁺, Ca²⁺, Sr²⁺, and Ba²⁺ is 1% or more, the effects thereof can be sufficiently obtained, and in a case in which the total amount is 50% or less, the glass is unlikely to be unstable. Therefore, the content of ΣR″²⁺ is preferably from 1% to 50%. The content of ΣR″²⁺ is more preferably 5% or more, still more preferably 10% or more, even more preferably 15% or more, and most preferably 20% or more. The content of R″²⁺ is more preferably 45% or less, still more preferably 40% or less, even more preferably 35% or less, and most preferably 32% or less.

Zinc (Zn) is effective to lower the melting temperature of glass, lower the liquid phase temperature of glass, and the like. The content of Zn²⁺ is preferably from 0% to 20%. In a case in which the content of Zn²⁺ is 20% or less, problems such as the glass becoming unstable, a deterioration in melting properties of the glass, and a decrease in near infrared ray cutting properties rarely occur. The content of Zn²⁺ is more preferably 15% or less, still more preferably 10% or less, and even more preferably 5% or less.

P⁵⁺ content/ΣR′ (R′ represents one or more components selected from Al³⁺, Mg²⁺, and Li⁺, and ΣR′ represents a total amount of R′) is preferably set to from 3.0 to 7.5.

P⁵⁺ is a component that increases the sharp cutting properties in a near infrared region, but also has a weather resistance decreasing effect. In addition, each of Al³⁺, Li⁺, and Mg⁺ is an effective component to improve the weather resistance.

Therefore, by setting the ratio of the P⁵⁺ content to ΣR′ to 7.5 or less, the weather resistance of glass can be improved. By setting the ratio of the P⁵⁺ content to ΣR′ to 3.0 or more, the sharp cutting properties of glass in a near infrared region can be maintained high. The ratio of the P⁵⁺ content to ΣR′ is more preferably 3.5 or more, still more preferably 4.0 or more, and even more preferably 4.5 or more. The ratio of the P⁵⁺ content to ΣR′ is more preferably 7.0 or less, still more preferably 6.5 or less, even more preferably 6.0 or less, and most preferably 5.5 or less.

Boron (B) may be contained in a range of 20% or less to stabilize glass. In a case in which the content of B³⁺ is 20% or less, problems such as a deterioration in weather resistance of glass and a decrease in near infrared ray cutting properties rarely occur. The content of B³⁺ is more preferably 15% or less, still more preferably 10% or less, even more preferably 8% or less, and most preferably 5% or less.

In the glass substrate 110, SiO₂, GeO₂, ZrO₂, SnO₂, TiO₂, CeO₂, WO₃, Y₂O₃, La₂O₃, Gd₂O₃, Yb₂O₃, and Nb₂O₅ may be contained in a range of 10% or less to increase the weather resistance of glass. In a case in which the content of the above components is 10% or less, problems such as the generation of devitrification foreign matter in the glass and a decrease in near infrared ray cutting properties rarely occur. The content of the above components is more preferably 4% or less, still more preferably 3% or less, even more preferably 2% or less, and most preferably 1% or less.

All of Fe₂O₃, Cr₂O₃, Bi₂O₃, NiO, V₂O₅, MnO₂, and CoO are components that decrease the light transmittance in a visible region when being present in glass. Therefore, it is preferable that these components are not substantially contained in glass. Here, “not substantially contained in glass” means that the components are not contained except as inevitable impurities, and means that the components are not positively added. Specifically, it means that the content of each of these components is about 100 ppm by mass or less in glass.

In addition, in the glass substrate 110, an expected value φ_{A} of the ionic radius of the alkali metal components expressed by the following Expression (4):

$${φ}_{A} ( pm ) = P / S \qquad Expression ( 4 )$$

is preferably from 70 pm (picometers) to 170 pm (picometers). In this way, the absorbing ability and the sharp cutting properties of the glass substrate 110 in a near infrared region can be improved, and the weather resistance can be improved.

Here, P represents a value obtained by obtaining the result of ionic radius (pm)×cation amount for each alkali metal component contained in the glass substrate 110 and adding up the results, and S represents the sum of the cation amounts of all of the alkali components. Here, the “cation amount” is a unit expressing the content of each cationic component by mol % when the total content of all cationic components contained in glass is set to 100 mol %.

In addition, the alkali metal components refer to the components including Li⁺, Na⁺, K⁺, Rb⁺, and Cs⁺, and the ionic radius of each alkali metal component is as follows. The ionic radius r_{Li} of Li⁺ is 60 μm, the ionic radius r_{Na} of Na^{m} is 95 μm, the ionic radius r_{K} of K⁺ is 133 μm, the ionic radius r_{Rb} of Rb⁺ is 148 μm, and the ionic radius res of Cs⁺ is 169 pm. These ionic radii are values based on literature: L. Pauling (1931-1933), THE NATURE OF THE CHEMICAL BOND (1963, translated by Masao Koizumi, Kyoritsu Shuppan Co., Ltd.).

For example, in a case in which the glass substrate 110 contains Li⁺, Na⁺, K⁺, Rb⁺, and Cs⁺, P (pm) is determined by ionic radius (60 pm) of Li⁺×cationic amount of Li⁺+ionic radius (95 nm) of Na⁺×cationic amount of Na⁺+ionic radius (133 pm) of K⁺×cationic amount of K⁺⁺ ionic radius (148 pm) of Rb⁺×cationic amount of Rb⁺⁺ ionic radius (169 pm) of Cs⁺×cationic amount of Cs.

The glass according to the embodiment of the invention can maintain a sharp absorption form with enhanced absorption in a near infrared region while maintaining a high transmittance in a red region by setting the expected value of the ionic radius of the alkali metal components (Li⁺, Na⁺, K⁺, Rb⁺, and Cs⁺) to 70 μm or more. The reason for this is presumed as follows.

Non-bridging oxygen is coordinated to Cu²⁺ in glass, and thus a regular octahedron is formed. In a case in which the symmetry of the non-bridging oxygen coordinated to Cu²⁺ is high, a sharp absorption peak is obtained in a near infrared region, but in a case in which the symmetry of the non-bridging oxygen is reduced for the reason to be described later, the absorption peak of Cu²⁺ is shifted, and the form of the transmittance curve of the glass changes from a sharp absorption form to a broad absorption form. It has been reported in “Kohei Kadono (2009), “Optical properties of glasses II”, NEW GLASS Vol. 24 No. 2” that an absorption spectrum of a transition metal containing Cu is likely to change due to a change in the coordination environment in glass.

The non-bridging oxygen coordinated to Cu²⁺ in glass is attracted to surrounding components having high electronegativity, and thus the symmetry is reduced. The electronegativity refers to properties indicating the strength of the force with which an atomic nucleus of an atom attracts surrounding electrons. In addition, the ionic radius refers to a value indicating a distance from an atomic nucleus of an atom to an outermost electron shell. In atoms of the same group, the greater the distance between the atomic nucleus and the bonding electron pair, the lower the electronegativity, and thus it can be said that a component having a large ionic radius has low electronegativity.

Therefore, when the glass contains a component having a large ionic radius among alkali metal components, the symmetry of the non-bridging oxygen coordinated to Cu²⁺ is not reduced, and it is possible to realize high absorbing ability in a near infrared region and high sharp cutting properties in a near infrared region.

Meanwhile, when the expected value of the ionic radius of the alkali metal components (Li⁺, Na⁺, K⁺, Rb⁺, and Cs⁺) is set to be larger than 170 pm, there is a concern about a decrease in weather resistance. The reason for this is presumed as follows.

The weather resistance is evaluated by the degree of deterioration of a glass surface caused when the glass is left under high temperature and high humidity for a long period of time. Under high temperature and high humidity, H present on the glass surface intrudes into the inside of the glass and attacks the —O—P—O— structure, thereby causing hydrolysis. As a result, H₃PO₄ desorbed from the glass surface remains in a liquid state, and further reacts with the glass, and the glass surface is deteriorated due to the precipitation of foreign matter. In a case in which an alkali metal component having a large ionic radius is contained in a large amount, the strength of attracting the non-bridging oxygen in the glass weakens, and the strength of the glass structure weakens. Therefore, when the glass is left under high temperature and high humidity for a long period of time, H⁺ present on the glass surface easily intrudes into the inside of the glass, that is, the hydrolysis reaction proceeds more readily, and the weather resistance of the glass decreases.

Based on the above description, the expected value of the ionic radius of the alkali metal components is desirably from 70 μm to 170 μm. In a case in which the expected value is 70 μm or more, the effects of high absorbing ability and an improvement in sharp cutting properties in a near infrared region can be sufficiently obtained, and in a case in which the expected value is 170 μm or less, problems such as a decrease in weather resistance rarely occur. Therefore, the expected value is more preferably 75 μm or more, still more preferably 80 μm or more, even more preferably 85 μm or more, and most preferably 90 μm or more. The expected value is more preferably 160 μm or less, still more preferably 150 μm or less, even more preferably 140 μm or less, and most preferably less than 133 pm.

In a case in which the optical filter according to one embodiment of the invention is used as, for example, a color correction filter of a solid state image sensor, the optical filter is often used at 3 mm or less. Therefore, the glass substrate 110 may have a thickness in a range of from 0.03 mm to 3 mm, for example. In addition, from the viewpoint of light-weight components, the glass substrate 110 preferably has a thickness of 1 mm or less, more preferably 0.5 mm or less, still more preferably 0.3 mm or less, and even more preferably 0.25 mm or less. In addition, the glass substrate 110 preferably has a thickness of 0.05 mm or more from the viewpoint of ensuring the strength of the glass.

The glass substrate 110 may have optical characteristics in which (i) a transmittance T_{g}(1200) at a wavelength of 1,200 nm is 25% or less
at an incident angle of 0° when converted to a thickness of 0.2 mm.

Furthermore, the glass substrate 110 may have spectral characteristics in which
(ii) a transmittance T_{g(420)} at a wavelength of 420 nm is 80% or more,
(iii) a transmittance T_{g(800)} at a wavelength of 800 nm is 6% or less, and
(iv) a wavelength λ_{g(t=50)1} at which the transmittance is 50% is in a range of from 600 nm to 670 nm
at an incident angle of 0° when converted to a thickness of 0.2 mm.

A method of calculating a transmittance when the thickness of the glass substrate 110 was converted was performed using the expression (Tᵢ₂=Tᵢ₁^{(t2/t1)}). Tᵢ₁ represents an internal transmittance of target glass (data excluding a reflection loss of the front and back surfaces), t1 represents a plate thickness of the target glass, Tᵢ₂ represents a transmittance converted, and t2 represents a plate thickness to be converted (for example, 0.2 mm). The conversion from the transmittance to the internal transmittance was performed using the following expression, assuming that a reflection loss Ref of each of the front and back surfaces of the glass was 0.0454.

$$Internal Transmittance = Transmittance / \{ 100 \times {( 1 - Ref )}^{2} \}$$

### (Resin Layer 140)

The resin layer 140 contains a resin and a dye that absorbs near infrared rays.

Such a dye may be selected from, for example, a squarylium dye, a phthalocyanine dye, and a cyanine dye. The dye may be selected from at least one selected from the group consisting of a cyanine dye, a phthalocyanine dye, a squarylium dye, a naphthalocyanine dye, and a diimmonium dye. Among these, a squarylium dye and a cyanine dye are preferable.

In addition, the resin layer 140 may contain two or more near infrared absorbing dyes.

In this case, a first near infrared absorbing dye may have a maximum absorption wavelength in a range of from 700 to 730 nm, and/or a second near infrared absorbing dye may have a maximum absorption wavelength in a range of from 740 to 800 nm.

The content of the near infrared absorbing dye contained in the resin layer 140 is preferably from 0.1 to 30 parts by mass, and more preferably from 0.1 to 20 parts by mass, with respect to 100 parts by mass of the resin. In a case in which two or more compounds are combined, the content is the sum of the compounds.

The resin layer 140 may contain other dyes such as ultraviolet light absorbing dyes as long as the effects of the invention are not impaired.

Examples of the ultraviolet light absorbing dyes include an oxazole dye, a merocyanine dye, a cyanine dye, a naphthalimide dye, an oxadiazole dye, an oxazine dye, an oxazolidine dye, a naphthalic acid dye, a styryl dye, an anthracene dye, a cyclic carbonyl dye, and a triazole dye. Among these, a merocyanine dye is particularly preferable. The above-described dyes may be used singly or in combination of two or more kinds thereof.

The resin contained in the resin layer 140 is not particularly limited as long as it is transparent.

The resin may be selected from, for example, a polyester resin, an acrylic resin, an epoxy resin, an ene-thiol resin, a polycarbonate resin, a polyether resin, a polyarylate resin, a polysulfone resin, a polyethersulfone resin, a polyparaphenylene resin, a polyarylene etherphosphine oxide resin, a polyamide resin, a polyimide resin, a polyamideimide resin, a polyolefin resin, a cyclic olefin resin, a polyurethane resin, a polystyrene resin, and the like. These resins may be used singly or in mixture of two or more kinds thereof.

From the viewpoint of the spectral characteristics, glass transition point (Tg), and adhesion of the resin layer 140, the resin is preferably selected from a polyimide resin, a polycarbonate resin, a polyester resin, and an acrylic resin.

### (First Optical Filter 100)

The first optical filter 100 has spectral characteristics in which, when light is incident from the second multilayer film 160 side,
(I) an average transmittance Tₜ₍₁₎ₐᵥₑ₁ at a wavelength of from 900 nm to 1,200 nm is 5% or less at an incident angle θ=0°, and an average transmittance Tₜ₍₁₎ₐᵥₑ₂ at a wavelength of from 900 nm to 1,200 nm is 5% or less at an incident angle θ=60°. Here, Tₜ₍₁₎ₐᵥₑ₁ is preferably 4.5% or less, more preferably 4.0% or less, and still more preferably 3.5% or less. Tₜ₍₁₎ₐᵥₑ₂ is preferably 4.5% or less, more preferably 4.0% or less, and still more preferably 3.5% or less.

In addition, the first optical filter 100 may have optical characteristics in which, when light is incident from the third multilayer film 150 side,
(II) a maximum reflectance Rₜ₁ₘₐₓ₁ in a wavelength range of from 450 nm to 950 nm is 20% or less at an incident angle θ=5°, and
(III) a maximum reflectance Rₜ₁ₘₐₓ₂ in a wavelength range of from 450 nm to 950 nm is 30% or less at an incident angle θ=60°.

Since the optical filter has the optical characteristics, it is possible to suppress the reflection on the optical filter side when reflected light from the sensor side is incident on the optical filter, for example. Therefore, it is possible to prevent unnecessary light from entering the sensor. Here, Rₜ₁ₘₐₓ₁ is more preferably 15% or less, and still more preferably 10% or less. Rₜ₁ₘₐₓ₂ is more preferably 25% or less.

In addition, the first optical filter 100 may have spectral characteristics in which, when light is incident from the second multilayer film 160 side,
(IV) an average transmittance Tₜ₍₂₎ₐᵥₑ₁ at a wavelength of from 440 nm to 500 nm is 80% or more at an incident angle θ=0°, and an average transmittance Tₜ₍₂₎ₐᵥₑ₂ at a wavelength of from 440 nm to 500 nm is 70% or more at an incident angle θ=60°,
(V) a wavelength λₜ₍ₜ₌₁₀₎₁ at which the transmittance is 10% is in a range of from 600 nm to 700 nm at an incident angle θ=0°,
(VI) a difference Δλₜ(absolute value) between a wavelength λₜ₍ₜ₌₁₀₎₂ at which the transmittance is 10% and λₜ₍ₜ₌₁₀₎₁ is 15 nm or less at an incident angle θ=60°, and
(VII) an average transmittance Tₜ₍₃₎ₐᵥₑ₁ at a wavelength of from 750 nm to 1,000 nm is 2% or less at an incident angle θ=0°, and an average transmittance Tₜ₍₃₎ₐᵥₑ₂ at a wavelength of from 750 nm to 1,000 nm is 2% or less at an incident angle θ=60°.

Here, Tₜ₍₂₎ₐᵥₑ₁ is more preferably 83% or more, and still more preferably 85% or more. Ti(2)ave2 is more preferably 73% or more, and still more preferably 75% or more. λₜ₍ₜ₌₁₀₎₁ is more preferably in a range of from 630 nm to 700 nm, and still more preferably in a range of from 650 nm to 700 nm. The difference Δλt (absolute value) between λₜ₍ₜ₌₁₀₎₂ and λₜ₍ₜ₌₁₀₎₁ is more preferably 13 nm or less, and still more preferably 12 nm or less. Tₜ₍₃₎ₐᵥₑ₁ is more preferably 1% or less, and still more preferably 0.5% or less. Tₜ₍₃₎ₐᵥₑ₂ is more preferably 1% or less, and still more preferably 0.5% or less.

In addition, the first optical filter 100 may have spectral characteristics in which, when light is incident from the second multilayer film 160 side,
(VIII) a maximum reflectance Rₜ₂ₘₐₓ₁ in a wavelength range of from 750 nm to 1,050 nm is 95% or more at an incident angle θ=5°, and
(IX) a maximum reflectance Rₜ₂ₘₐₓ₂ in a wavelength range of from 750 nm to 1,050 nm is 95% or more at an incident angle θ=60°.

Rₜ₂ₘₐₓ₁ is more preferably 97% or more, and still more preferably 99% or more. Rₜ₂ₘₐₓ₂ is more preferably 97% or more, and still more preferably 99% or more.

Furthermore, the first optical filter 100 may have spectral characteristics in which, when light is incident from the second multilayer film 150 side,
(X) an average transmittance Tₜ₍₄₎ₐᵥₑ₁ at a wavelength of from 900 nm to 1,000 nm is 0.5% or less at an incident angle θ=0°. Tₜ₍₄₎ₐᵥₑ₁ is more preferably 0.1% or less, and still more preferably 0.05% or less.

In addition, the first optical filter 100 may have spectral characteristics in which, when light is incident from the second multilayer film 150 side,
(XI) a transmittance Tₜ₍₅₎₁ at a wavelength of 1,000 nm is 2% or less at an incident angle θ=0°, and a transmittance Tₜ₍₅₎₂ at a wavelength of 1,000 nm is 2% or less at an incident angle θ=60°. Tₜ₍₅₎₁ is more preferably 1% or less, still more preferably 0.1% or less, and particularly preferably 0.05% or less.

In addition, the first optical filter 100 may have spectral characteristics in which, when light is incident from the second multilayer film 150 side,
(XII) a transmittance Tₜ₍₆₎₁ at a wavelength of 1,100 nm is 6% or less at an incident angle θ=0°, and a transmittance Tₜ₍₆₎₂ at a wavelength of 1,100 nm is 6% or less at an incident angle θ=60°. Tₜ₍₅₎₁ is more preferably 5% or less, and still more preferably 4.0% or less. Tₜ₍₅₎₂ is more preferably 5% or less, and still more preferably 4.5% or less.

In addition, the first optical filter 100 may have spectral characteristics in which, when light is incident from the second multilayer film 150 side,
(XIII) a difference ΔTₜ(absolute value) between Tₜ₍₂₎ₐᵥₑ₁ and Tₜ₍₂₎ₐᵥₑ₂ is 15% or less. ΔTₜ is more preferably 13% or less, and still more preferably 11% or less.

In addition, the first optical filter 100 may have spectral characteristics in which, when light is incident from the second multilayer film 150 side,
(XIV) an average reflectance Rₜ₃ₐᵥₑ₁ in a wavelength range of from 800 nm to 1,200 nm is 50% or more and 90% or less at an incident angle θ=5°. Rₜ₃ₐᵥₑ₁ is more preferably 60% or more and 85% or less, and still more preferably 60% or more and 80% or less.

### (Method of Manufacturing Optical Filter According to One Embodiment of Invention)

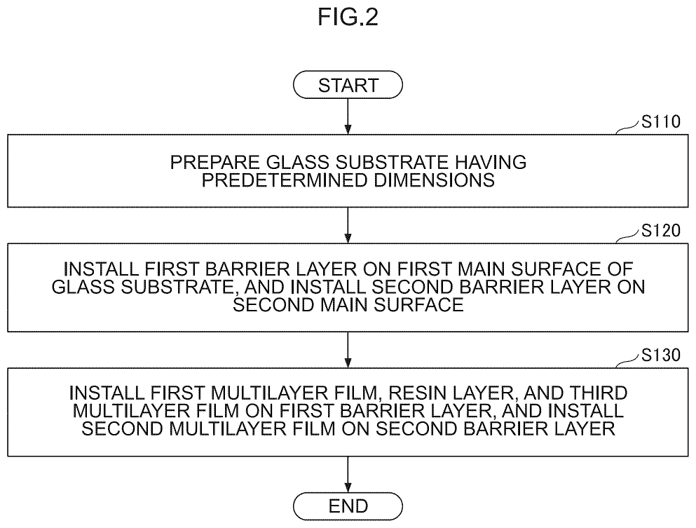

Next, an example of a method of manufacturing the optical filter according to one embodiment of the invention will be described with reference to FIG. 2. FIG. 2 is a flowchart schematically showing an example of the method of manufacturing an optical filter according to one embodiment of the invention.

As shown in FIG. 2, the method of manufacturing an optical filter according to one embodiment of the invention (hereinafter, referred to as “first method”) includes:
a step of preparing a glass substrate having predetermined dimensions (Step S110),
a step of installing a first barrier layer on a first main surface of the glass substrate and installing a second barrier layer on a second main surface (Step S120), and
a step of installing a first multilayer film, a resin layer, and a third multilayer film on the first barrier layer and installing a second multilayer film on the second barrier layer (Step S130).

Hereinafter, the steps will be described.

Here, a method of manufacturing the first optical filter 100 will be described as an example. Therefore, the reference numerals shown in FIG. 1 are used to represent the respective members.

### (Step S110)

First, a glass substrate is prepared. As described above, the glass substrate 110 has the first main surface 112 and the second main surface 114, and is made of fluorophosphate glass containing an absorbent.

### (Step S120)

Next, the first barrier layer 120 is installed on the first main surface 112 of the glass substrate 110, and the second barrier layer 130 is installed on the second main surface 214.

The first barrier layer 120 and the second barrier layer 130 (hereinafter, referred to collectively as a “barrier layer”) may be made of the same material or different materials. For example, each of the barriers may be made of a titanium oxide.

The method of forming the barrier layer is not particularly limited. The barrier layer may be formed by, for example, a vapor deposition method or a sputtering method.

### (Step S130)

Thereafter, necessary members for the first optical filter 100 are sequentially formed on the glass substrate 110. Specifically, the first multilayer film 135, the resin layer 140, and the third multilayer film 150 are sequentially installed on the first barrier layer 120, and the second multilayer film 160 is installed on the second barrier layer 130.

As described above, the first multilayer film 135 is formed by alternately forming high refractive index films and low refractive index films. The method for forming the first multilayer film 135 is not particularly limited. For example, a general film forming method such as a sputtering method may be used.

In addition, the resin layer 140 is made from, for example, a resin solution containing a dye.

The resin solution may be prepared by dissolving a dye in a solution containing a resin, an organic solvent, and the like. The dye may include an infrared absorbing dye and an ultraviolet absorbing dye as described above.

Next, the resin solution is applied onto the first multilayer film by a coating method such as a spin coating method. Thereafter, the coating film is dried to form the resin layer 140.

Thereafter, the third multilayer film 150 is installed on the resin layer 140.

The third multilayer film 150 can be formed by the same method as the first multilayer film 135.

Through the above steps, the first optical filter 100 can be manufactured.

It should be noted that the above description is merely an example, and it is apparent to those skilled in the art that the first optical filter 100 may be manufactured by another manufacturing method.

For example, in the first method, the barrier layers 120 and 130 are formed on both of the main surfaces 112 and 114 of the glass substrate 110, respectively, in Step S120, and then the remaining layers are installed in Step S130.

Alternatively, however, the second barrier layer 130 and the second multilayer film 160 may be formed on the second main surface 114 of the glass substrate 110, and then necessary layers may be sequentially formed on the first main surface 112 of the glass substrate 110. Conversely, all necessary layers may be formed on the first main surface 112 of the glass substrate 110, and then necessary layers may be sequentially formed on the second main surface 114 of the glass substrate 110.

In addition, various changes can be made.

The optical filter according to one embodiment of the invention can be applied to, for example, an image pickup device such as a digital still camera. Such an image pickup device can provide good color reproducibility.

An image pickup device including the optical filter according to one embodiment of the invention may further have a solid state image sensor and an imaging lens, and the optical filter may be disposed, for example, between the imaging lens and the solid state image sensor. In addition, the optical filter according to one embodiment of the invention may be directly adhered to the solid state image sensor and/or the imaging lens of the image pickup device via an adhesive layer, for example.

### EXAMPLES

In order to evaluate the durability of a glass substrate used in an optical filter according to one embodiment of the invention, the following preliminary experiments were performed.

### Experiment 1

A high-temperature and high-humidity test for 1,000 hours was performed using a glass substrate. The test temperature was set to 85° C., and the relative humidity was set to 85%.

As the glass substrate, 0.2 mm-thick fluorophosphate glass having a composition shown in “Glass A” in the following Table 1 was used.

TABLE 1

| Mass % | Glass A | Glass B | Glass C | Glass D | Glass E | Glass F | Glass G | Glass H |
|---|---|---|---|---|---|---|---|---|
| P⁵⁺ | 35.3 | 34.5 | 35.9 | 35.5 | 36.9 | 36.3 | 35.1 | 37.8 |
| Al³⁺ | 6.5 | 8.6 | 7.3 | 7.2 | 7.5 | 9.1 | 7.1 | 6.9 |
| Li⁺ | — | — | — | — | — | — | — | 4.7 |
| Na⁺ | — | — | 3.4 | 1.7 | 7.5 | 7.3 | — | — |
| K⁺ | 24.2 | 23.7 | 18.8 | 21.5 | 12.7 | 12.5 | 24.1 | — |
| Rb⁺ | — | — | — | — | — | — | — | — |
| Cs⁺ | — | — | — | — | — | — | — | — |
| Mg²⁺ | — | — | — | — | — | — | — | 2.2 |
| Ca²⁺ | 4.3 | 4.2 | 4.4 | 4.3 | 4.5 | 4.4 | 4.3 | 5.0 |
| Sr²⁺ | 6.8 | 6.7 | 6.9 | 6.9 | 7.1 | 7.0 | 6.8 | 13.7 |
| Ba²⁺ | 14.4 | 14.1 | 14.6 | 14.5 | 15.0 | 14.8 | 14.3 | 22.2 |
| Cu²⁺ | 8.4 | 8.3 | 8.6 | 8.5 | 8.8 | 8.7 | 8.4 | 7.5 |
| Zn²⁺ | — | — | — | — | — | — | — | — |
| total | 100.0 | 100.0 | 100.0 | 100.0 | 100.0 | 100.0 | 100.0 | 100.0 |
| F⁻ | 14.90 | 18.7 | 15.9 | 16.4 | 17.1 | 18.4 | 16.8 | 12.70 |
| φ_{A} | 133.0 | 133.0 | 124.0 | 128.5 | 114.0 | 114.0 | 133.0 | 60.0 |

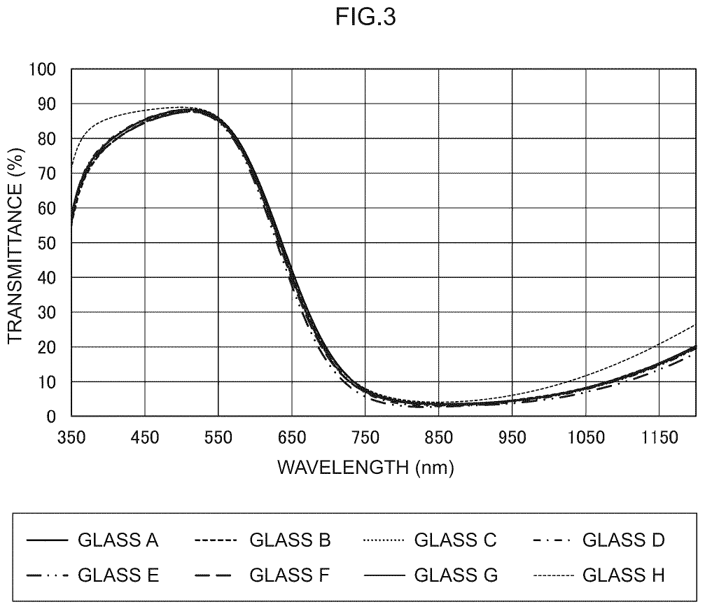

The optical characteristics of the used glass substrate are shown in the curve of the glass A in FIG. 3. In addition, in the column of the glass A in the following Table 2, optical parameters of the glass A corresponding to the above-described (i) to (iv), calculated from the measured optical characteristics, are shown.

TABLE 2

| Optical | Glass | | | | | | | |
|---|---|---|---|---|---|---|---|---|
| Parameters | A | B | C | D | E | F | G | H |
| Transmittance | 20.3 | 20.3 | 19.6 | 19.6 | 18.1 | 20.1 | 19.8 | 26.5 |
| T_{g(1200)} | | | | | | | | |
| Transmittance | 82.1 | 81.2 | 82.1 | 82.3 | 81.1 | 81.1 | 82.0 | 86.9 |
| T_{g(420)} | | | | | | | | |
| Transmittance | 4.4 | 4.2 | 4.1 | 3.6 | 3.0 | 4.3 | 4.0 | 4.8 |
| T_{g(800)} | | | | | | | | |
| λ_{g (t = 50)1} | 636 | 634 | 633 | 633 | 629 | 632 | 634 | 634 |

### Experiment 2

With the following method, a glass substrate (hereinafter, referred to as “coated substrate”) having a first main surface coated with a first barrier layer and a first multilayer film, and a second main surface coated with a second barrier layer and a second multilayer film was prepared.

First, a glass substrate of 20 mm in length×20 mm in width×0.2 mm in thickness was prepared. As the glass substrate, fluorophosphate glass having the composition shown in “Glass A” was used.

Next, a first barrier layer was formed on a first main surface of the glass substrate by a vapor deposition method. The first barrier layer was an alumina layer, and had a thickness of 12 nm.

Next, a first multilayer film was formed on the first barrier layer. The first multilayer film was formed of alternating layers of silica and titania.

As the first multilayer film, a multilayer film (hereinafter, referred to as “multilayer film A”) having a configuration shown in the following Table 3 was used.

TABLE 3

| | | Thickness |
|---|---|---|
| Layer No. | Material | (nm) |
| 1 | SiO₂ | 34.15 |
| 2 | TiO₂ | 117.29 |
| 3 | SiO₂ | 39.59 |
| 4 | TiO₂ | 23.07 |
| 5 | SiO₂ | 41.67 |
| 6 | TiO₂ | 116.75 |
| 7 | SiO₂ | 45.18 |
| 8 | TiO₂ | 19.22 |
| 9 | SiO₂ | 45.29 |
| 10 | TiO₂ | 111.37 |
| 11 | SiO₂ | 51.58 |
| 12 | TiO₂ | 15.7 |
| 13 | SiO₂ | 53.65 |
| 14 | TiO₂ | 110.69 |
| 15 | SiO₂ | 53.86 |
| 16 | TiO₂ | 14.69 |
| 17 | SiO₂ | 53.3 |
| 18 | TiO₂ | 107.31 |
| 19 | SiO₂ | 55.26 |
| 20 | TiO₂ | 12.93 |
| 21 | SiO₂ | 61.3 |
| 22 | TiO₂ | 109.66 |
| 23 | SiO₂ | 66.79 |
| 24 | TiO₂ | 12 |
| 25 | SiO₂ | 62.86 |
| 26 | TiO₂ | 118.46 |
| 27 | SiO₂ | 48.22 |
| 28 | TiO₂ | 23.55 |
| 29 | SiO₂ | 40.27 |
| 30 | TiO₂ | 137 |
| 31 | SiO₂ | 24.46 |
| 32 | TiO₂ | 39.16 |
| 33 | SiO₂ | 22.25 |
| 34 | TiO₂ | 144.97 |
| 35 | SiO₂ | 29.42 |
| 36 | TiO₂ | 30.99 |
| 37 | SiO₂ | 34.81 |
| 38 | TiO₂ | 126.83 |
| 39 | SiO₂ | 48.34 |
| 40 | TiO₂ | 19.43 |
| 41 | SiO₂ | 50.32 |
| 42 | TiO₂ | 116.83 |
| 43 | SiO₂ | 49.21 |
| 44 | TiO₂ | 18.77 |
| 45 | SiO₂ | 44.15 |
| 46 | TiO₂ | 103.58 |
| 47 | SiO₂ | 84.86 |

| | |
|---|---|
| Total | 2791 |

In Table 3, the layer numbers are listed in order of closest to the glass substrate (this notation will also be used in the tables showing configurations of multilayer films to be described later). The total thickness of the first barrier layer and the first multilayer film is about 2,803 nm.

Similarly, a second barrier layer and a second multilayer film were formed on a second main surface of the glass substrate. The second barrier layer was an alumina layer, and had a thickness of 12 nm. In addition, the multilayer film A was used as the second multilayer film. The total thickness of the second barrier layer and the second multilayer film is about 2,803 nm.

The high-temperature and high-humidity test was performed using the obtained coated substrate.

### Experiment 3

The same experiment as Experiment 2 was performed.

In Experiment 3, a titania layer having a thickness of 12 nm was used as first and second barrier layers. In addition, a multilayer film B having a configuration shown in the following Table 4 was used as a first multilayer film and a second multilayer film.

TABLE 4

| | | Thickness |
|---|---|---|
| Layer No. | Material | (nm) |
| 1 | TiO₂ | 12 |
| 2 | SiO₂ | 34.15 |
| 3 | TiO₂ | 117.29 |
| 4 | SiO₂ | 39.59 |
| 5 | TiO₂ | 23.07 |
| 6 | SiO₂ | 41.67 |
| 7 | TiO₂ | 116.75 |
| 8 | SiO₂ | 45.18 |
| 9 | TiO₂ | 19.22 |
| 10 | SiO₂ | 45.29 |
| 11 | TiO₂ | 111.37 |
| 12 | SiO₂ | 51.58 |
| 13 | TiO₂ | 15.7 |
| 14 | SiO₂ | 53.65 |
| 15 | TiO₂ | 110.69 |
| 16 | SiO₂ | 53.86 |
| 17 | TiO₂ | 14.69 |
| 18 | SiO₂ | 53.3 |
| 19 | TiO₂ | 107.31 |
| 20 | SiO₂ | 55.26 |
| 21 | TiO₂ | 12.93 |
| 22 | SiO₂ | 61.3 |
| 23 | TiO₂ | 109.66 |
| 24 | SiO₂ | 66.79 |
| 25 | TiO₂ | 12 |
| 26 | SiO₂ | 62.86 |
| 27 | TiO₂ | 118.46 |
| 28 | SiO₂ | 48.22 |
| 29 | TiO₂ | 23.55 |
| 30 | SiO₂ | 40.27 |
| 31 | TiO₂ | 137 |
| 32 | SiO₂ | 24.46 |
| 33 | TiO₂ | 39.16 |
| 34 | SiO₂ | 22.25 |
| 35 | TiO₂ | 144.97 |
| 36 | SiO₂ | 29.42 |
| 37 | TiO₂ | 30.99 |
| 38 | SiO₂ | 34.81 |
| 39 | TiO₂ | 126.83 |
| 40 | SiO₂ | 48.34 |
| 41 | TiO₂ | 19.43 |
| 42 | SiO₂ | 50.32 |
| 43 | TiO₂ | 116.83 |
| 44 | SiO₂ | 49.21 |
| 45 | TiO₂ | 18.77 |
| 46 | SiO₂ | 44.15 |
| 47 | TiO₂ | 103.58 |
| 48 | SiO₂ | 84.86 |

| | |
|---|---|
| Total | 2803 |

The total thickness of the first barrier layer and the first multilayer film is about 2,815 nm. In addition, the total thickness of the second barrier layer and the second multilayer film is about 2,815 nm.

### Experiment 4

The high-temperature and high-humidity test was performed in the same manner as in Experiment 1. In Experiment 4, fluorophosphate glass having a thickness of 0.2 mm and having the composition shown in “Glass B” in Table 1 was used as a glass substrate.

The optical characteristics of the used glass substrate are shown in the curve of the glass B in FIG. 3. In addition, in the column of the glass B in Table 2, optical parameters of the glass B corresponding to the above-described (i) to (iv), calculated from the measured optical characteristics, are shown.

### Experiment 5

A coated substrate was prepared in the same manner as in Experiment 2.

In Experiment 5, the glass B in Table 1 was used as a glass substrate. The high-temperature and high-humidity test was performed using the obtained coated substrate.

### Experiment 6

A coated substrate was prepared in the same manner as in Experiment 3.

In Experiment 6, the glass B in Table 1 was used as a glass substrate. The high-temperature and high-humidity test was performed using the obtained coated substrate.

### Evaluation

After the high-temperature and high-humidity test, the coated substrate (or uncoated glass substrate) was taken out to perform the following barrier property evaluation.

The coated substrate is observed from the first main surface side using a microscope. At a location where the glass substrate inside the first main surface is most eroded, a distance from a nearest end surface is measured. In a case in which the measured distance is less than 100 μm, the barrier properties are determined as “A”, in a case in which the distance is 100 μm or more and less than 150 μm, the barrier properties are determined as “B”, in a case in which the distance is 150 μm or more and less than 250 μm, the barrier properties are determined as “C”, and in a case in which the distance is more than 250 μm, the barrier properties are determined as “D”.

The following Table 5 collectively shows the results of the high-temperature and high-humidity tests in the respective experiments.

TABLE 5

| | | | First | | Second | |
|---|---|---|---|---|---|---|
| | | First | Multi- | Second | Multi- | |
| Exper- | Glass | Barrier | layer | Barrier | layer | Evaluation |
| iment | Substrate | Layer | Film | Layer | Film | Result |
| 1 | A | None | None | None | None | D |
| 2 | A | Al₂O₃ | Multi- | Al₂O₃ | Multi- | C |
| | | | layer | | layer | |
| | | | Film A | | Film A | |
| 3 | A | TiO₂ | Multi- | TiO₂ | Multi- | B |
| | | | layer | | layer | |
| | | | Film B | | Film B | |
| 4 | B | None | None | None | None | D |
| 5 | B | Al₂O₃ | Multi- | Al₂O₃ | Multi- | A |
| | | | layer | | layer | |
| | | | Film A | | Film A | |
| 6 | B | TiO₂ | Multi- | TiO₂ | Multi- | A |
| | | | layer | | layer | |
| | | | Film B | | Film B | |

From these results, it was found that glass elution occurred in the glass substrates of Experiments 1 and 4 in which the barrier layer and the multilayer film were not formed on the main surface.

In contrast, it was found that glass elution was significantly suppressed in the coated substrates of Experiments 2, 3, 5, and 6 in which the barrier layer and the multilayer film were formed on both of the main surfaces.

### Experiment 7

A coated substrate was prepared by the following method.

First, a glass substrate of 20 mm in length×20 mm in width×0.5 mm in thickness was prepared. As the glass substrate, fluorophosphate glass having the composition shown in “Glass B” was used.

Next, a first barrier layer was formed on a first main surface of the glass substrate by a vapor deposition method. The first barrier layer was made of titania, and had a thickness of 12 nm.

Next, a first multilayer film was formed on the first barrier layer. The first multilayer film was formed of alternating layers of silica and titania.

As the first multilayer film, a multilayer film having a configuration shown in the following Table 6 was used.

TABLE 6

| Layer No. | Material | Thickness (nm) |
|---|---|---|
| 1 | SiO₂ | 53.25 |
| 2 | TiO₂ | 20.65 |
| 3 | SiO₂ | 58.15 |
| 4 | TiO₂ | 10 |
| 5 | SiO₂ | 2001.5 |

| | |
|---|---|
| Total | 2144 |

In Table 6, the layer numbers are listed in order of closest to the glass substrate. The total thickness of the first barrier layer and the first multilayer film is about 2,156 nm.

Similarly, a second barrier layer and a second multilayer film were formed on a second main surface of the glass substrate. The second barrier layer was a titania layer, and had a thickness of 12 nm. In addition, as the second multilayer film, the multilayer film shown in Table 6 was used.

The high-temperature and high-humidity test was performed using the obtained coated substrate.

As a result, the determination result of the barrier properties was “A”, and it was found that glass elution was significantly suppressed in the coated substrate of Experiment 7.

### EXAMPLES

Hereinafter, examples of the invention will be described. In the following description, Examples 1 to 14 are examples, and Example 21 is a comparative example.

### Example 1

An optical filter was prepared by the following method.

First, a second barrier layer and a second multilayer film were formed on the second main surface side of a glass substrate by a vapor deposition method.

As the glass substrate, fluorophosphate glass (thickness: 0.2 mm) having the composition shown in “Glass A” in Table 1 was used.

The second barrier layer was made of titania with a thickness of 13.46 nm. In addition, the second multilayer film was formed of alternating layers of silica and titania.

The following Table 7 shows a configuration of the second multilayer film.

TABLE 7

Second Multilayer Film

| | | Thickness |
|---|---|---|
| Layer No. | Material | (nm) |
| 1 | SiO₂ | 35.91 |
| 2 | TiO₂ | 122.19 |
| 3 | SiO₂ | 54.43 |
| 4 | TiO₂ | 16.5 |
| 5 | SiO₂ | 56.34 |
| 6 | TiO₂ | 114.35 |
| 7 | SiO₂ | 56.99 |
| 8 | TiO₂ | 13.78 |
| 9 | SiO₂ | 56.98 |
| 10 | TiO₂ | 105.53 |
| 11 | SiO₂ | 50.31 |
| 12 | TiO₂ | 13.84 |
| 13 | SiO₂ | 53.62 |
| 14 | TiO₂ | 104.72 |
| 15 | SiO₂ | 56.61 |
| 16 | TiO₂ | 13.45 |
| 17 | SiO₂ | 54.46 |
| 18 | TiO₂ | 106.8 |
| 19 | SiO₂ | 57.43 |
| 20 | TiO₂ | 14.28 |
| 21 | SiO₂ | 58.28 |
| 22 | TiO₂ | 114.06 |
| 23 | SiO₂ | 62.37 |
| 24 | TiO₂ | 13.85 |
| 25 | SiO₂ | 61.9 |
| 26 | TiO₂ | 118.14 |
| 27 | SiO₂ | 63.3 |
| 28 | TiO₂ | 13.92 |
| 29 | SiO₂ | 60.87 |
| 30 | TiO₂ | 121.02 |
| 31 | SiO₂ | 53.44 |
| 32 | TiO₂ | 20 |
| 33 | SiO₂ | 49.62 |
| 34 | TiO₂ | 127.66 |
| 35 | SiO₂ | 40.8 |
| 36 | TiO₂ | 27.53 |
| 37 | SiO₂ | 40.05 |
| 38 | TiO₂ | 130.36 |
| 39 | SiO₂ | 44.52 |
| 40 | TiO₂ | 22.59 |
| 41 | SiO₂ | 47.67 |
| 42 | TiO₂ | 122.93 |
| 43 | SiO₂ | 52.55 |
| 44 | TiO₂ | 18.77 |
| 45 | SiO₂ | 48.14 |
| 46 | TiO₂ | 111.04 |
| 47 | SiO₂ | 88.3 |

| | |
|---|---|
| Total | 2892 |

Next, a first barrier layer and a first multilayer film were formed on the first main surface side of the glass substrate.

The first barrier layer was made of titania with a thickness of 12 nm. In addition, the first multilayer film was formed of alternating layers of silica and titania. The total thickness of the first barrier layer and the first multilayer film is about 2,154 nm.

In the column of a configuration I-1 in the following Table 8, a configuration of the first multilayer film is shown.

TABLE 8

Configuration I-1

| Layer | | Thickness | |
|---|---|---|---|
| No. | Material | (nm) | QWOT |
| 1 | SiO₂ | 53.25 | 0.57 |
| 2 | TiO₂ | 20.65 | 0.37 |
| 3 | SiO₂ | 58.15 | 0.62 |
| 4 | TiO₂ | 10 | 0.18 |
| 5 | SiO₂ | 2000 | 21.34 |

Configuration I-2

| Layer | | Thickness | |
|---|---|---|---|
| No. | Material | (nm) | QWOT |
| 1 | SiO₂ | 36.6 | 0.39 |
| 2 | TiO₂ | 35 | 0.63 |
| 3 | SiO₂ | 38.95 | 0.42 |
| 4 | TiO₂ | 15.45 | 0.28 |
| 5 | SiO₂ | 2000 | 21.34 |

Configuration I-3

| Layer | | Thickness | |
|---|---|---|---|
| No. | Material | (nm) | QWOT |
| 1 | SiO₂ | 25 | 0.27 |
| 2 | TiO₂ | 49.98 | 0.90 |
| 3 | SiO₂ | 25 | 0.27 |
| 4 | TiO₂ | 17.88 | 0.32 |
| 5 | SiO₂ | 2000 | 21.34 |

Configuration I-4

| Layer | | Thickness | |
|---|---|---|---|
| No. | Material | (nm) | QWOT |
| 1 | SiO₂ | 20 | 0.21 |
| 2 | TiO₂ | 74.83 | 1.35 |
| 3 | SiO₂ | 20 | 0.21 |
| 4 | TiO₂ | 15.27 | 0.27 |
| 5 | SiO₂ | 2000 | 21.34 |

Configuration I-5

| Layer | | Thickness | |
|---|---|---|---|
| No. | Material | (nm) | QWOT |
| 1 | SiO₂ | 10.98 | 0.12 |
| 2 | TiO₂ | 60.47 | 1.09 |
| 3 | SiO₂ | 11 | 0.12 |
| 4 | TiO₂ | 16.19 | 0.29 |
| 5 | SiO₂ | 2000 | 21.34 |

Next, a resin layer was formed on the first multilayer film by the following method.

First, a liquid for a resin layer was prepared. The liquid for a resin layer was prepared as follows.

A polyimide resin (C3G30G, refractive index 1.59; manufactured by MITSUBISHI GAS CHEMICAL COMPANY, INC.) was dissolved in γ-butyrolactone (GBL):cyclohexanone=1:1 (mass ratio) to prepare a solution having a resin concentration of 8.5 mass %.

Next, a compound A, a compound B, a compound C and a compound D as dyes were added to the diluted solution, and the resultant mixture was stirred for dissolution at 50° C. for 2 hours to prepare the liquid for a resin layer.

The amounts of the compound A, the compound B, the compound C, and the compound D added were 4.16 mass %, 1.17 mass %, 2.21 mass %, and 3.24 mass %, respectively, with respect to the resin content.

The following Table 9 collectively shows specifications of the compound A, the compound B, the compound C, and the compound D.

TABLE 9

| | Maximum | | |
|---|---|---|---|
| | Absorption | | |
| Compound | Wavelength | Dye Classification | Source |
| A | 772 | Cyanine Compound | Dyes and Pigments, 73, |
| | | | 344-352 (2007) |
| B | 752 | Squarylium compound | PCT International Publication No. |
| | | | WO2017/135359 |
| C | 722 | Squarylium compound | PCT International Publication No. |
| | | | WO2014/088063 |
| | | | PCT International Publication No. |
| | | | WO2016/133099 |
| D | 397 | Merocyanine Compound | German Patent Publication No. |
| | | | 10109243 |

The compound A, the compound B, the compound C, and the compound D are represented by the following general formulas, respectively.

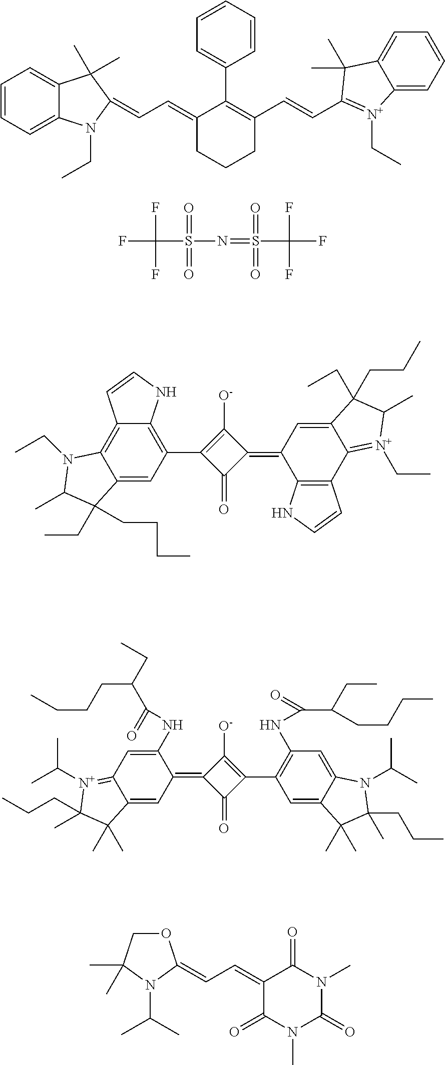

Next, the liquid for a resin layer was spin-coated on the first multilayer film. The target thickness was 1 m. Thereafter, the liquid for a resin layer was dried to form a resin layer.

Next, a third multilayer film was formed on the resin layer.

The following Table 10 shows a configuration of the third multilayer film.

TABLE 10

| Layer No. | Material | Thickness (nm) |
|---|---|---|
| 1 | TiO₂ | 9.11 |
| 2 | SiO₂ | 63.49 |
| 3 | TiO₂ | 24.2 |
| 4 | SiO₂ | 25.88 |
| 5 | TiO₂ | 77.82 |
| 6 | SiO₂ | 13.38 |
| 7 | TiO₂ | 29.12 |
| 8 | SiO₂ | 105.16 |

| | |
|---|---|
| Total | 348 |

Accordingly, an optical filter was obtained. The prepared optical filter is referred to as “optical filter 1”.

### Example 2

An optical filter was prepared in the same manner as in Example 1. In Example 2, the configuration of a first multilayer film was changed compared to that in Example 1.

In the column of a configuration I-2 in Table 8, a configuration of the first multilayer film used in Example 2 is shown.

Accordingly, an optical filter was obtained. The prepared optical filter is referred to as “optical filter 2”.

### Example 3

An optical filter was prepared in the same manner as in Example 1. In Example 3, the configuration of a first multilayer film was changed compared to that in Example 1.

In the column of a configuration I-3 in Table 8, a configuration of the first multilayer film used in Example 3 is shown.

Accordingly, an optical filter was obtained. The prepared optical filter is referred to as “optical filter 3”.

### Example 4

An optical filter was prepared in the same manner as in Example 1. In Example 4, the configuration of a first multilayer film was changed compared to that in Example 1.

In the column of a configuration I-4 in Table 8, a configuration of the first multilayer film used in Example 4 is shown.

Accordingly, an optical filter was obtained. The prepared optical filter is referred to as “optical filter 4”.

### Example 5

An optical filter was prepared in the same manner as in Example 1. In Example 5, the configuration of a first multilayer film was changed compared to that in Example 1.

In the column of a configuration I-5 in Table 8, a configuration of the first multilayer film used in Example 5 is shown.

Accordingly, an optical filter was obtained. The prepared optical filter is referred to as “optical filter 5”.

### Example 6

An optical filter was prepared in the same manner as in Example 1.

In Example 6, a configuration shown in Table 11 was used for a second multilayer film.

TABLE 11

| | | Thickness |
|---|---|---|
| Layer No. | Material | (nm) |
| 1 | SiO₂ | 33.5 |
| 2 | TiO₂ | 125.54 |
| 3 | SiO₂ | 36.02 |
| 4 | TiO₂ | 28.17 |
| 5 | SiO₂ | 38.78 |
| 6 | TiO₂ | 130.72 |
| 7 | SiO₂ | 42.29 |
| 8 | TiO₂ | 24.98 |
| 9 | SiO₂ | 43.72 |
| 10 | TiO₂ | 127.92 |
| 11 | SiO₂ | 40.34 |
| 12 | TiO₂ | 25.93 |
| 13 | SiO₂ | 40.44 |
| 14 | TiO₂ | 127.81 |
| 15 | SiO₂ | 40.46 |
| 16 | TiO₂ | 25.99 |
| 17 | SiO₂ | 41.57 |
| 18 | TiO₂ | 129.07 |
| 19 | SiO₂ | 44.26 |
| 20 | TiO₂ | 24.23 |
| 21 | SiO₂ | 46.21 |
| 22 | TiO₂ | 127.56 |
| 23 | SiO₂ | 43.14 |
| 24 | TiO₂ | 25.22 |
| 25 | SiO₂ | 40.57 |
| 26 | TiO₂ | 123.8 |
| 27 | SiO₂ | 37.42 |
| 28 | TiO₂ | 24.87 |
| 29 | SiO₂ | 38.93 |
| 30 | TiO₂ | 123.33 |
| 31 | SiO₂ | 47.59 |
| 32 | TiO₂ | 21.55 |
| 33 | SiO₂ | 49.04 |
| 34 | TiO₂ | 123.94 |
| 35 | SiO₂ | 48.44 |
| 36 | TiO₂ | 21.84 |
| 37 | SiO₂ | 45.26 |
| 38 | TiO₂ | 120.42 |
| 39 | SiO₂ | 42.96 |
| 40 | TiO₂ | 21.83 |
| 41 | SiO₂ | 43.36 |
| 42 | TiO₂ | 120.32 |
| 43 | SiO₂ | 51.66 |
| 44 | TiO₂ | 19.61 |
| 45 | SiO₂ | 50.27 |
| 46 | TiO₂ | 122.03 |
| 47 | SiO₂ | 49.39 |
| 48 | TiO₂ | 20.83 |
| 49 | SiO₂ | 41.7 |
| 50 | TiO₂ | 117.44 |
| 51 | SiO₂ | 40.05 |
| 52 | TiO₂ | 21.28 |
| 53 | SiO₂ | 42.33 |
| 54 | TiO₂ | 109.79 |
| 55 | SiO₂ | 98.48 |

| | |
|---|---|
| Total | 3294 |

Accordingly, an optical filter was obtained. The prepared optical filter is referred to as “optical filter 6”.

### Example 7

An optical filter was prepared in the same manner as in Example 1.

In Example 7, fluorophosphate glass having the composition shown in “Glass B” in Table 1 was used as a glass substrate.

Thereafter, the optical filter was prepared through the same steps as those in Example 1.

Hereinafter, the obtained optical filter is referred to as “optical filter 7”.

### Example 8

An optical filter was prepared in the same manner as in Example 1.

In Example 8, fluorophosphate glass having the composition shown in “Glass C” in Table 1 was used as a glass substrate.

The optical characteristics of the used glass substrate are shown in the curve of the glass C in FIG. 3. In addition, in the column of the glass C in Table 2, optical parameters of the glass C of the used glass substrate corresponding to the above-described (i) to (iv) are shown.

Thereafter, the optical filter was prepared through the same steps as those in Example 1.

Hereinafter, the obtained optical filter is referred to as “optical filter 8”.

### Example 9

An optical filter was prepared in the same manner as in Example 1.

In Example 9, fluorophosphate glass having the composition shown in “Glass D” in Table 1 was used as a glass substrate.

The optical characteristics of the used glass substrate are shown in the curve of the glass D in FIG. 3. In addition, in the column of the glass D in Table 2, optical parameters of the glass D of the used glass substrate corresponding to the above-described (i) to (iv) are shown.

Thereafter, the optical filter was prepared through the same steps as those in Example 1.

Hereinafter, the obtained optical filter is referred to as “optical filter 9”.

### Example 10

An optical filter was prepared in the same manner as in Example 1.

In Example 10, fluorophosphate glass having the composition shown in “Glass E” in Table 1 was used as a glass substrate.

The optical characteristics of the used glass substrate are shown in the curve of the glass E in FIG. 3. In addition, in the column of the glass E in Table 2, optical parameters of the glass E of the used glass substrate corresponding to the above-described (i) to (iv) are shown.

Thereafter, the optical filter was prepared through the same steps as those in Example 1.

Hereinafter, the obtained optical filter is referred to as “optical filter 10”.

### Example 11

An optical filter was prepared in the same manner as in Example 1.

In Example 11, fluorophosphate glass having the composition shown in “Glass F” in Table 1 was used as a glass substrate.

The optical characteristics of the used glass substrate are shown in the curve of the glass F in FIG. 3. In addition, in the column of the glass F in Table 2, optical parameters of the glass F of the used glass substrate corresponding to the above-described (i) to (iv) are shown.

Thereafter, the optical filter was prepared through the same steps as those in Example 1.

Hereinafter, the obtained optical filter is referred to as “optical filter 11”.

### Example 12

An optical filter was prepared in the same manner as in Example 1.

In Example 12, fluorophosphate glass having the composition shown in “Glass G” in Table 1 was used as a glass substrate.

The optical characteristics of the used glass substrate are shown in the curve of the glass G in FIG. 3. In addition, in the column of the glass G in Table 2, optical parameters of the glass G of the used glass substrate corresponding to the above-described (i) to (iv) are shown.

Thereafter, the optical filter was prepared through the same steps as those in Example 1.

Hereinafter, the obtained optical filter is referred to as “optical filter 12”.

### Example 13

An optical filter was prepared by the following method.

First, a second barrier layer and a second multilayer film were formed on the second main surface side of a glass substrate by a vapor deposition method.

As the glass substrate, fluorophosphate glass (thickness: 0.2 mm) having the composition shown in “Glass E” in Table 1 was used.

The second barrier layer was made of alumina with a thickness of 12 nm. In addition, the second multilayer film was formed of alternating layers of silica and titania.

The following Table 12 shows a configuration of the second multilayer film.

TABLE 12

| Film No. | Material | Thickness (nm) |
|---|---|---|
| 1 | TiO₂ | 12 |
| 2 | SiO₂ | 34.15 |
| 3 | TiO₂ | 117.29 |
| 4 | SiO₂ | 39.59 |
| 5 | TiO₂ | 23.07 |
| 6 | SiO₂ | 41.67 |
| 7 | TiO₂ | 116.75 |
| 8 | SiO₂ | 45.18 |
| 9 | TiO₂ | 19.22 |
| 10 | SiO₂ | 45.29 |
| 11 | TiO₂ | 111.37 |
| 12 | SiO₂ | 51.58 |
| 13 | TiO₂ | 15.7 |
| 14 | SiO₂ | 53.65 |
| 15 | TiO₂ | 110.69 |
| 16 | SiO₂ | 53.86 |
| 17 | TiO₂ | 14.69 |
| 18 | SiO₂ | 53.3 |
| 19 | TiO₂ | 107.31 |
| 20 | SiO₂ | 55.26 |
| 21 | TiO₂ | 12.93 |
| 22 | SiO₂ | 61.3 |
| 23 | TiO₂ | 109.66 |
| 24 | SiO₂ | 66.79 |
| 25 | TiO₂ | 12 |
| 26 | SiO₂ | 62.86 |
| 27 | TiO₂ | 118.46 |
| 28 | SiO₂ | 48.22 |
| 29 | TiO₂ | 23.55 |
| 30 | SiO₂ | 40.27 |
| 31 | TiO₂ | 137 |
| 32 | SiO₂ | 24.46 |
| 33 | TiO₂ | 39.16 |
| 34 | SiO₂ | 22.25 |
| 35 | TiO₂ | 144.97 |
| 36 | SiO₂ | 29.42 |
| 37 | TiO₂ | 30.99 |
| 38 | SiO₂ | 34.81 |
| 39 | TiO₂ | 126.83 |
| 40 | SiO₂ | 48.34 |
| 41 | TiO₂ | 19.43 |
| 42 | SiO₂ | 50.32 |
| 43 | TiO₂ | 116.83 |
| 44 | SiO₂ | 49.21 |
| 45 | TiO₂ | 18.77 |
| 46 | SiO₂ | 44.15 |
| 47 | TiO₂ | 103.58 |
| 48 | SiO₂ | 84.86 |

| | |
|---|---|
| Total | 2803 |

Next, a first barrier layer and a first multilayer film were formed on the first main surface side of the glass substrate.

The first barrier layer was made of alumina with a thickness of 12 nm. In addition, the first multilayer film was formed of alternating layers of silica and titania. The total thickness of the first barrier layer and the first multilayer film is about 1,664 nm.

The following Table 13 shows a configuration of the first multilayer film.

TABLE 13

| Film No. | Material | Thickness (nm) | QWOT |
|---|---|---|---|
| 1 | TiO₂ | 12 | 0.22 |
| 2 | SiO₂ | 52.13 | 0.56 |
| 3 | TiO₂ | 20.87 | 0.38 |
| 4 | SiO₂ | 57.01 | 0.61 |
| 5 | TiO₂ | 10 | 0.18 |
| 6 | SiO₂ | 1500 | 16.01 |

Next, a resin layer was formed on the first multilayer film by the following method.

First, a liquid for a resin layer was prepared. The liquid for a resin layer was prepared as follows.

A polyimide resin (C3G30G, refractive index 1.59; manufactured by MITSUBISHI GAS CHEMICAL COMPANY, INC.) was dissolved in γ-butyrolactone (GBL):cyclohexanone=1:1 (mass ratio) to prepare a solution having a resin concentration of 8.5 mass %.

Next, the compound B and the compound D as dyes were added to the diluted solution, and the resultant mixture was stirred for dissolution at 50° C. for 2 hours to prepare the liquid for a resin layer.

The amounts of the compound B and the compound D added were 6.4 mass % and 6.9 mass %, respectively, with respect to the resin content.

Next, the liquid for a resin layer was spin-coated on the first multilayer film. The target thickness was 1 m. Thereafter, the liquid for a resin layer was dried to form a resin layer.

Next, a third multilayer film was formed on the resin layer.

The following Table 14 shows a configuration of the third multilayer film.

TABLE 14

| Film No. | Material | Thickness (nm) |
|---|---|---|
| 1 | SiO₂ | 47.15 |
| 2 | TiO₂ | 8.86 |
| 3 | SiO₂ | 61.71 |
| 4 | TiO₂ | 23.52 |
| 5 | SiO₂ | 25.16 |
| 6 | TiO₂ | 75.64 |
| 7 | SiO₂ | 13 |
| 8 | TiO₂ | 28.31 |
| 9 | SiO₂ | 102.22 |

| | |
|---|---|
| Total | 386 |

Accordingly, an optical filter was obtained. The prepared optical filter is referred to as “optical filter 13”.

### Example 14

An optical filter was prepared in the same manner as in Example 13. In Example 14, the configuration of a first multilayer film was changed compared to that in Example 13.

The following Table 15 shows a configuration of the first multilayer film.

TABLE 15

| Film No. | Material | Thickness (nm) | QWOT |
|---|---|---|---|
| 1 | TiO₂ | 12 | 0.22 |
| 2 | SiO₂ | 52.13 | 0.56 |
| 3 | TiO₂ | 20.87 | 0.38 |
| 4 | SiO₂ | 57.01 | 0.61 |
| 5 | TiO₂ | 10 | 0.18 |
| 6 | SiO₂ | 47.15 | 0.50 |

Accordingly, an optical filter was obtained. The prepared optical filter is referred to as “optical filter 14”.

### Example 21

An optical filter was prepared in the same manner as in Example 1.

In Example 21, fluorophosphate glass having the composition shown in “Glass H” in Table 1 was used as a glass substrate.

The optical characteristics of the used glass substrate are shown in the curve of the glass H in FIG. 3. In addition, in the column of the glass H in Table 2, optical parameters of the glass H of the used glass substrate corresponding to the above-described (i) to (iv) are shown.

Thereafter, the optical filter was prepared through the same steps as those in Example 1.

Hereinafter, the obtained optical filter is referred to as “optical filter 21”.

The following Table 16 collectively shows the configuration of each optical filter, the value of X determined as described above, and the like.

TABLE 16

| | | | | | | Total | | | | | | | | |
|---|---|---|---|---|---|---|---|---|---|---|---|---|---|---|
| | | | | | | Thick- | | | | | | | | |
| | | | | | | ness (nm) | | | | | | | | |
| | | | | | | of First | | | | | | | | |
| | | | | | Config- | Barrier | | | Config- | | | | Config- | |
| | | | | | uration | Layer and | | | uration | | | | uration | |
| | | First Barrier Layer | | | of First | First | | | of Third | Second Barrier Layer | | | of Second | |
| | Glass | | Thick- | Content | Multi- | Multi- | X | X′ | Multi- | | Thick- | Content | Multi- | Dura- |
| Optical | Sub- | | ness | Ratio | layer | layer | Value | Value | layer | | ness | Ratio | layer | bility |
| Filter | strate | Material | (nm) | (mol %) | Film | Film | (%) | (%) | Film | Material | (nm) | (mol %) | Film | Test |
| 1 | A | TiO₂ | 12 | 100 | I-1 | 2154.05 | 72.3 | 72.3 | Table 9 | TiO₂ | 13.46 | 100 | Table 6 | B |
| 2 | A | TiO₂ | 15.89 | 100 | I-2 | 2141.89 | 53.2 | 53.2 | Table 9 | TiO₂ | 13.46 | 100 | Table 6 | — |
| 3 | A | TiO₂ | 17.54 | 100 | I-3 | 2135.4 | 36.9 | 36.9 | Table 9 | TiO₂ | 13.46 | 100 | Table 6 | — |
| 4 | A | TiO₂ | 15.24 | 100 | I-4 | 2145.34 | 27.5 | 27.5 | Table 9 | TiO₂ | 13.46 | 100 | Table 6 | — |
| 5 | A | TiO₂ | 13.25 | 100 | I-5 | 2111.89 | 19.6 | 19.6 | Table 9 | TiO₂ | 13.46 | 100 | Table 6 | — |
| 6 | A | TiO₂ | 12 | 100 | I-1 | 2154.05 | 72.3 | 72.3 | Table 9 | TiO₂ | 13.46 | 100 | Table 10 | B |
| 7 | B | TiO₂ | 12 | 100 | I-1 | 2154.05 | 72.3 | 72.3 | Table 9 | TiO₂ | 13.46 | 100 | Table 6 | A |
| 8 | C | TiO₂ | 12 | 100 | I-1 | 2154.05 | 72.3 | 72.3 | Table 9 | TiO₂ | 13.46 | 100 | Table 6 | A |
| 9 | D | TiO₂ | 12 | 100 | I-1 | 2154.05 | 72.3 | 72.3 | Table 9 | TiO₂ | 13.46 | 100 | Table 6 | A |
| 10 | E | TiO₂ | 12 | 100 | I-1 | 2154.05 | 72.3 | 72.3 | Table 9 | TiO₂ | 13.46 | 100 | Table 6 | A |
| 11 | F | TiO₂ | 12 | 100 | I-1 | 2154.05 | 72.3 | 72.3 | Table 9 | TiO₂ | 13.46 | 100 | Table 6 | A |
| 12 | G | TiO₂ | 12 | 100 | I-1 | 2154.05 | 72.3 | 72.3 | Table 9 | TiO₂ | 13.46 | 100 | Table 6 | A |
| 13 | E | Al₂O₃ | 12 | 100 | Table 13 | 1664.01 | 73.9 | 66.5 | Table 14 | Al₂O₃ | 12 | 100 | Table 12 | A |
| 14 | E | Al₂O₃ | 12 | 100 | Table 15 | 211.16 | 79.7 | 74.0 | Table 14 | Al₂O₃ | 12 | 100 | Table 12 | A |
| 21 | H | TiO₂ | 12 | 100 | I-1 | 2154.05 | 72.3 | 72.3 | Table 9 | TiO₂ | 13.46 | 100 | Table 6 | — |

### Evaluation

The following evaluations were performed using each optical filter.

### (Evaluation of Durability)

The high-temperature and high-humidity test was performed using each optical filter. The test time was set to 1,000 hours.

As a result of observation after the test, in the optical filters 7 to 14, elution from the glass substrate was rarely observed. Therefore, all of the optical filters 7 to 14 were determined as “A” based on the criteria. In addition, the optical filters 1 and 6 were determined as “B”.

### (Evaluation of Optical Characteristics)

The optical characteristics were evaluated using each optical filter. For the measurement, a UV-VIS-NIR spectrophotometer (UH4150: manufactured by Hitachi High-Tech Corporation) was used.

In the measurement of a transmittance, light was made incident from the second multilayer film side in each optical filter.

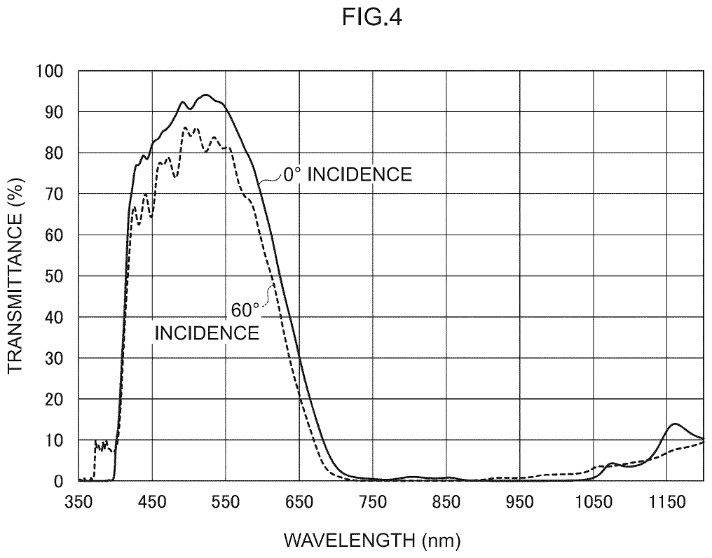

FIG. 4 shows an example of a transmittance profile obtained from the optical filter 1. In FIG. 4, the horizontal axis represents a wavelength, and the vertical axis represents a transmittance. FIG. 4 shows the results at both incident angles θ=0° and θ=60°.

As shown in FIG. 4, in the optical filter 1, it is found that the influence of the incident angle θ on the transmittance profile is rarely recognized. That is, in a visible light region, a high transmittance was obtained regardless of the incident angle θ. In addition, even in a case in which the incident angle θ was changed, a region where the transmittance rapidly decreased rarely changed. Furthermore, it was found that the transmittance was low in an infrared region regardless of the incident angle θ.

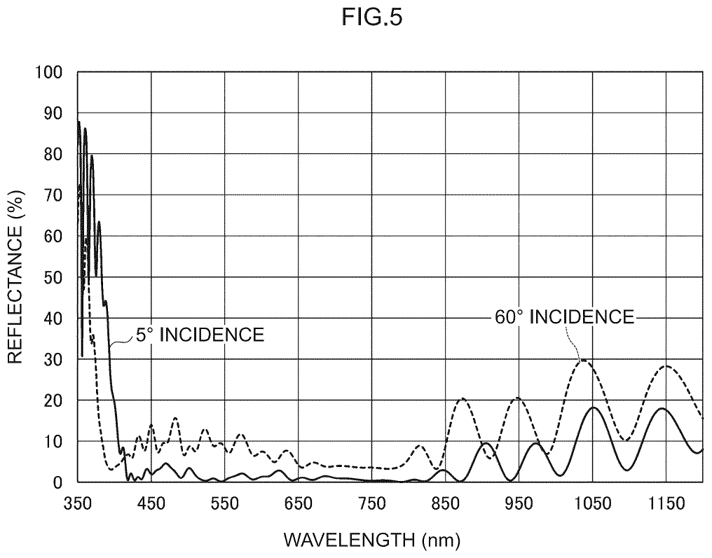

FIG. 5 shows an example of a reflectance profile obtained from the optical filter 1, with respect to light incident from the third multilayer film side. In FIG. 5, the horizontal axis represents a wavelength, and the vertical axis represents a reflectance. FIG. 5 shows the results at both incident angles θ=5° and θ=60°.

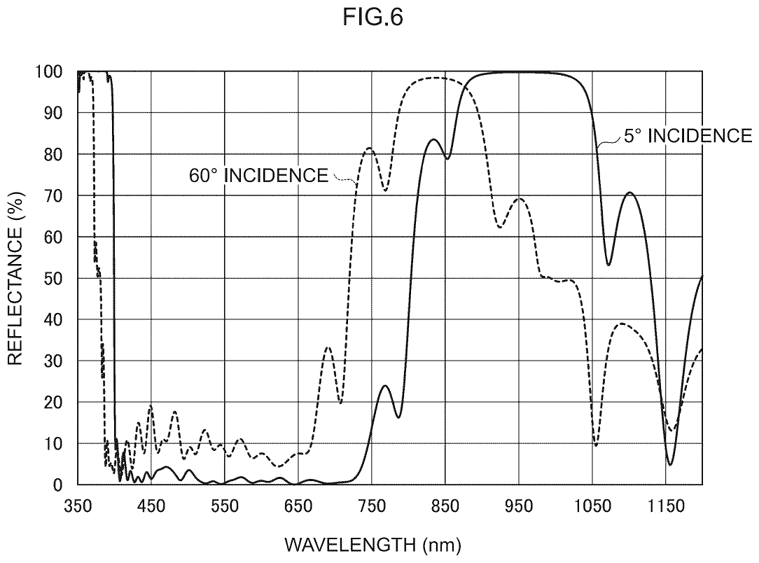

FIG. 6 shows an example of a reflectance profile obtained from the optical filter 1, with respect to light incident from the second multilayer film side. In FIG. 6, the horizontal axis represents a wavelength, and the vertical axis represents a reflectance. FIG. 6 shows the results at both incident angles θ=5° and θ=60°.

The following Table 17 collectively shows parameters related to the spectral characteristics measured in the respective optical filters.

TABLE 17

| | Optical Filter | | | | | | | |
|---|---|---|---|---|---|---|---|---|
| Optical Parameters | 1 | 2 | 3 | 4 | 5 | 6 | 7 | 8 |
| Average Transmittance | 3.7 | 3.5 | 3.4 | 3.2 | 3.3 | 4.8 | 3.7 | 3.6 |
| Tₜ₍₁₎ₐᵥₑ₁ at Wavelength | | | | | | | | |
| of from 900 nm to | | | | | | | | |
| 1,200 nm at Incident | | | | | | | | |
| Angle θ = 0° | | | | | | | | |
| Average Transmittance | 3.5 | 3.4 | 3.3 | 3.1 | 3.2 | 3.9 | 3.5 | 3.4 |
| Tₜ₍₁₎ₐᵥₑ₂ at Wavelength | | | | | | | | |
| of from 440 nm to | | | | | | | | |
| 500 nm at Incident | | | | | | | | |
| Angle θ = 60° | | | | | | | | |
| Maximum Reflectance | 9.5 | 15.8 | 21.6 | 25.0 | 28.4 | 9.5 | 9.6 | 9.4 |
| Rₜ₁ₘₐₓ₁ in Wavelength | | | | | | | | |
| Range of from 450 nm | | | | | | | | |
| to 950 nm for Light | | | | | | | | |
| at Incident Angle | | | | | | | | |
| θ = 5° from Third | | | | | | | | |
| Multilayer Film Side | | | | | | | | |
| Maximum Reflectance | 20.5 | 27.3 | 32.7 | 36.1 | 37.5 | 20.5 | 20.7 | 20.5 |
| Rₜ₁ₘₐₓ₂ in Wavelength | | | | | | | | |
| Range of from 450 nm | | | | | | | | |
| to 950 nm for Light | | | | | | | | |
| at Incident Angle | | | | | | | | |
| θ = 60° from Third | | | | | | | | |
| Multilayer Film Side | | | | | | | | |
| Average Transmittance | 86.1 | 86.1 | 85.9 | 85.8 | 85.8 | 85.9 | 85.4 | 86.1 |
| Tₜ₍₂₎ₐᵥₑ₁ at Wavelength | | | | | | | | |
| of from 440 nm to | | | | | | | | |
| 500 nm at Incident | | | | | | | | |
| Angle θ = 0° | | | | | | | | |
| Average Transmittance | 75.9 | 75.8 | 75.6 | 75.1 | 75.6 | 78.0 | 75.1 | 75.9 |
| Tₜ₍₂₎ₐᵥₑ₂ at Wavelength | | | | | | | | |
| of from 440 nm to | | | | | | | | |
| 500 nm at Incident | | | | | | | | |
| Angle θ = 60° | | | | | | | | |
| Wavelength λₜ₍ₜ₌₁₀₎₁ | 682 | 682 | 681 | 682 | 680 | 682 | 681 | 681 |
| at Which Transmittance | | | | | | | | |
| is 10% at Incident | | | | | | | | |
| Angle θ = 0° | | | | | | | | |
| Difference Δλₜ | 12 | 13 | 13 | 14 | 13 | 10 | 13 | 13 |
| (absolute value) | | | | | | | | |
| Between Wavelength | | | | | | | | |
| λₜ₍ₜ₌₁₀₎₂ at Which | | | | | | | | |
| Transmittance is 10% at | | | | | | | | |
| Incident Angle θ = 60° | | | | | | | | |
| and λₜ₍ₜ₌₁₀₎₁ | | | | | | | | |
| Average Transmittance | 0.3 | 0.3 | 0.3 | 0.3 | 0.3 | 0.9 | 0.3 | 0.3 |
| Tₜ₍₃₎ₐᵥₑ₁ at Wavelength | | | | | | | | |
| of from 750 nm to | | | | | | | | |
| 1,000 nm at Incident | | | | | | | | |
| Angle θ = 0° | | | | | | | | |
| Average Transmittance | 0.4 | 0.4 | 0.4 | 0.4 | 0.4 | 0.5 | 0.4 | 0.4 |
| Tₜ₍₃₎ₐᵥₑ₂ at Wavelength | | | | | | | | |
| of from 750 nm to | | | | | | | | |
| 1,000 nm at Incident | | | | | | | | |
| Angle θ = 60° | | | | | | | | |
| Maximum Reflectance | 99.7 | 99.7 | 99.7 | 99.7 | 99.7 | 99.8 | 99.8 | 99.8 |
| Rₜ₂ₘₐₓ₁ in Wavelength | | | | | | | | |
| Range of from 750 nm | | | | | | | | |
| to 1,050 nm for Light | | | | | | | | |
| at Incident Angle | | | | | | | | |
| θ = 5° from Second | | | | | | | | |
| Multilayer Film Side | | | | | | | | |
| Maximum Reflectance | 98.4 | 98.4 | 98.4 | 98.4 | 98.4 | 98.4 | 98.4 | 98.4 |
| Rₜ₂ₘₐₓ₂ in Wavelength | | | | | | | | |
| Range of from 750 nm | | | | | | | | |
| to 1,050 nm for Light | | | | | | | | |
| at Incident Angle | | | | | | | | |
| θ = 60° from Second | | | | | | | | |
| Multilayer Film Side | | | | | | | | |
| Average Transmittance | 0.017 | 0.016 | 0.016 | 0.015 | 0.015 | 0.018 | 0.017 | 0.017 |
| Tₜ₍₄₎ₐᵥₑ₁ at Wavelength | | | | | | | | |
| of from 900 nm to | | | | | | | | |
| 1,000 nm at Incident | | | | | | | | |
| Angle θ = 0° | | | | | | | | |
| Transmittance Tₜ₍₅₎₁ | 0.034 | 0.034 | 0.033 | 0.034 | 0.033 | 0.034 | 0.033 | 0.035 |
| at Wavelength of | | | | | | | | |
| 1,000 nm at Incident | | | | | | | | |
| Angle θ = 0° | | | | | | | | |
| Transmittance Tₜ₍₅₎₂ | 1.6 | 1.6 | 1.8 | 1.6 | 1.6 | 1.5 | 1.6 | 1.7 |
| at Wavelength of | | | | | | | | |
| 1,000 nm at Incident | | | | | | | | |
| Angle θ = 60° | | | | | | | | |
| Transmittance Tₜ₍₆₎₁ | 3.5 | 3.6 | 5.6 | 3.6 | 3.6 | 3.5 | 3.4 | 3.6 |
| at Wavelength of | | | | | | | | |
| 1,100 nm at Incident | | | | | | | | |
| Angle θ = 0° | | | | | | | | |
| Transmittance Tₜ₍₆₎₂ | 4.4 | 4.4 | 5.9 | 4.4 | 4.5 | 4.3 | 4.2 | 4.4 |
| at Wavelength of | | | | | | | | |
| 1,100 nm at Incident | | | | | | | | |
| Angle θ = 60° | | | | | | | | |
| Difference (absolute | 10.2 | 10.3 | 10.3 | 10.7 | 10.2 | 7.9 | 10.3 | 10.2 |
| value) ΔTₜ Between | | | | | | | | |
| Tₜ₍₂₎ₐᵥₑ₁ and Tₜ₍₂₎ₐᵥₑ | | | | | | | | |
| Average Reflectance | 75.8 | 75.8 | 58.7 | 75.8 | 75.8 | 75.8 | 75.8 | 75.8 |
| Rₜ₃ₐᵥₑ₁ in Wavelength | | | | | | | | |
| Range of from 800 nm | | | | | | | | |
| to 1,200 nm for Light | | | | | | | | |
| at Incident Angle | | | | | | | | |
| θ = 60° from Second | | | | | | | | |
| Multilayer Film Side | | | | | | | | |

| | Optical Filter | | | | | | |
|---|---|---|---|---|---|---|---|
| Optical Parameters | 9 | 10 | 11 | 12 | 13 | 14 | 21 |
| Average Transmittance | 3.5 | 3.3 | 3.7 | 3.6 | 4.3 | 4.3 | 5.2 |
| Tₜ₍₁₎ₐᵥₑ₁ at Wavelength | | | | | | | |
| of from 900 nm to | | | | | | | |
| 1,200 nm at Incident | | | | | | | |
| Angle θ = 0° | | | | | | | |
| Average Transmittance | 3.3 | 3.0 | 3.5 | 3.4 | 3.4 | 3.4 | 5.6 |
| Tₜ₍₁₎ₐᵥₑ₂ at Wavelength | | | | | | | |
| of from 440 nm to | | | | | | | |
| 500 nm at Incident | | | | | | | |
| Angle θ = 60° | | | | | | | |
| Maximum Reflectance | 9.5 | 9.2 | 9.3 | 9.4 | 11.4 | 8.2 | 8.6 |
| Rₜ₁ₘₐₓ₁ in Wavelength | | | | | | | |
| Range of from 450 nm | | | | | | | |
| to 950 nm for Light | | | | | | | |
| at Incident Angle | | | | | | | |
| θ = 5° from Third | | | | | | | |
| Multilayer Film Side | | | | | | | |
| Maximum Reflectance | 20.5 | 20.3 | 20.3 | 20.5 | 20.3 | 22.5 | 19.3 |
| Rₜ₁ₘₐₓ₂ in Wavelength | | | | | | | |
| Range of from 450 nm | | | | | | | |
| to 950 nm for Light | | | | | | | |
| at Incident Angle | | | | | | | |
| θ = 60° from Third | | | | | | | |
| Multilayer Film Side | | | | | | | |
| Average Transmittance | 86.2 | 85.4 | 85.4 | 86.1 | 89.8 | 89.8 | 89.2 |
| Tₜ₍₂₎ₐᵥₑ₁ at Wavelength | | | | | | | |
| of from 440 nm to | | | | | | | |
| 500 nm at Incident | | | | | | | |
| Angle θ = 0° | | | | | | | |
| Average Transmittance | 76.0 | 75.2 | 75.2 | 75.8 | 80.7 | 80.9 | 79.3 |
| Tₜ₍₂₎ₐᵥₑ₂ at Wavelength | | | | | | | |
| of from 440 nm to | | | | | | | |
| 500 nm at Incident | | | | | | | |
| Angle θ = 60° | | | | | | | |
| Wavelength λₜ₍ₜ₌₁₀₎₁ | 681 | 679 | 680 | 681 | 686 | 686 | 681 |
| at Which Transmittance | | | | | | | |
| is 10% at Incident | | | | | | | |
| Angle θ = 0° | | | | | | | |
| Difference Δλₜ | 13 | 13 | 13 | 13 | 13 | 13 | 12 |
| (absolute value) | | | | | | | |
| Between Wavelength | | | | | | | |
| λₜ₍ₜ₌₁₀₎₂ at Which | | | | | | | |
| Transmittance is 10% at | | | | | | | |
| Incident Angle θ = 60° | | | | | | | |
| and λₜ₍ₜ₌₁₀₎₁ | | | | | | | |
| Average Transmittance | 0.3 | 0.2 | 0.3 | 0.3 | 0.2 | 0.2 | 0.4 |
| Tₜ₍₃₎ₐᵥₑ₁ at Wavelength | | | | | | | |
| of from 750 nm to | | | | | | | |
| 1,000 nm at Incident | | | | | | | |
| Angle θ = 0° | | | | | | | |
| Average Transmittance | 0.4 | 0.3 | 0.4 | 0.4 | 0.4 | 0.4 | 0.6 |
| Tₜ₍₃₎ₐᵥₑ₂ at Wavelength | | | | | | | |
| of from 750 nm to | | | | | | | |
| 1,000 nm at Incident | | | | | | | |
| Angle θ = 60° | | | | | | | |
| Maximum Reflectance | 99.8 | 99.7 | 99.7 | 99.7 | 99.6 | 99.6 | 99.7 |
| Rₜ₂ₘₐₓ₁ in Wavelength | | | | | | | |
| Range of from 750 nm | | | | | | | |
| to 1,050 nm for Light | | | | | | | |
| at Incident Angle | | | | | | | |
| θ = 5° from Second | | | | | | | |
| Multilayer Film Side | | | | | | | |
| Maximum Reflectance | 98.4 | 98.4 | 98.4 | 98.4 | 97.4 | 97.4 | 98.4 |
| Rₜ₂ₘₐₓ₂ in Wavelength | | | | | | | |
| Range of from 750 nm | | | | | | | |
| to 1,050 nm for Light | | | | | | | |
| at Incident Angle | | | | | | | |
| θ = 60° from Second | | | | | | | |
| Multilayer Film Side | | | | | | | |
| Average Transmittance | 0.016 | 0.015 | 0.017 | 0.017 | 0.030 | 0.030 | 0.024 |
| Tₜ₍₄₎ₐᵥₑ₁ at Wavelength | | | | | | | |
| of from 900 nm to | | | | | | | |
| 1,000 nm at Incident | | | | | | | |
| Angle θ = 0° | | | | | | | |
| Transmittance Tₜ₍₅₎₁ | 0.029 | 0.033 | 0.032 | 0.035 | — | — | 0.051 |
| at Wavelength of | | | | | | | |
| 1,000 nm at Incident | | | | | | | |
| Angle θ = 0° | | | | | | | |
| Transmittance Tₜ₍₅₎₂ | 1.3 | 1.6 | 1.5 | 1.6 | — | — | 2.7 |
| at Wavelength of | | | | | | | |
| 1,000 nm at Incident | | | | | | | |
| Angle θ = 60° | | | | | | | |
| Transmittance Tₜ₍₆₎₁ | 3.1 | 3.4 | 3.4 | 3.5 | — | — | 5.1 |
| at Wavelength of | | | | | | | |
| 1,100 nm at Incident | | | | | | | |
| Angle θ = 0° | | | | | | | |
| Transmittance Tₜ₍₆₎₂ | 3.7 | 4.2 | 4.2 | 4.4 | — | — | 7.1 |
| at Wavelength of | | | | | | | |
| 1,100 nm at Incident | | | | | | | |
| Angle θ = 60° | | | | | | | |
| Difference (absolute | 10.2 | 10.3 | 10.3 | 10.2 | — | — | 9.9 |
| value) ΔTₜ Between | | | | | | | |
| Tₜ₍₂₎ₐᵥₑ₁ and Tₜ₍₂₎ₐᵥₑ | | | | | | | |
| Average Reflectance | 75.7 | 75.8 | 75.8 | 75.7 | — | — | 75.6 |
| Rₜ₃ₐᵥₑ₁ in Wavelength | | | | | | | |
| Range of from 800 nm | | | | | | | |
| to 1,200 nm for Light | | | | | | | |
| at Incident Angle | | | | | | | |
| θ = 60° from Second | | | | | | | |
| Multilayer Film Side | | | | | | | |

As shown in Table 17, in the optical filters 1 to 14, it was confirmed that it was possible to obtain a sufficiently high transmittance in a visible light region. In addition, in the optical filters 1 to 14, it was confirmed that light in an infrared region was sufficiently blocked. In addition, in the optical filters 1 to 14, it was found that the optical characteristics did not change much even in a case in which the incident angle θ changed.

In contrast, the optical filter 21 did not have sufficient shieldability in an infrared region since the glass H, which was conventional fluorophosphate glass, was used as the glass substrate. In particular, it was found that, at incident angles θ=0° and 60°, the average transmittance Tₜ₍₁₎ₐᵥₑ₁ at a wavelength of from 900 nm to 1,200 nm was higher than in the optical filters 1 to 14.

In addition, comparing the optical filters 1, 2, and 6 to 14 in which the X value (%) was controlled within the preferable range with the optical filters 3 to 5, it was found that the optical filters 1, 2, and 6 to 14 exhibited a lower reflectance on the third multilayer film side. Specifically, it was found that the maximum reflectance in a wavelength range of from 450 nm to 950 nm was low at incident angles θ=5° and 60° from the third multilayer film side.

### Aspects of Invention

The present invention includes the following aspects.

### Aspect 1

An optical filter including: a glass substrate,
in which the glass substrate has a first main surface and a second main surface opposite to each other;
a first barrier layer, a first multilayer film, and a resin layer are disposed on the first main surface of the glass substrate in this order from the glass substrate side;
a second barrier layer and a second multilayer film are disposed on the second main surface of the glass substrate in this order from the glass substrate side;
a third multilayer film is disposed on the resin layer;
the glass substrate is fluorophosphate glass containing an infrared absorbent;
the first barrier layer and the second barrier layer each independently contain an oxide of at least one metal selected from the group consisting of aluminum (Al), titanium (Ti), niobium (Nb), tantalum (Ta), and hafnium (Hf) at a ratio of 80 mol % or more,
the resin layer contains a near infrared absorbing dye having a maximum absorption wavelength in a range of from 700 nm to 800 nm,
the first multilayer film, the second multilayer film, and the third multilayer film each independently include a plurality of dielectric layers, and
the optical filter has spectral characteristics in which
when light is incident from a side of the second multilayer film,
(I) an average transmittance Tₜ₍₁₎ₐᵥₑ₁ at a wavelength of from 900 nm to 1,200 nm is 5% or less at an incident angle θ=0°, and an average transmittance Tₜ₍₁₎ₐᵥₑ₂ at a wavelength of from 900 nm to 1,200 nm is 5% or less at an incident angle θ=60°.

### Aspect 2

The optical filter according to Aspect 1,
in which, in a portion in which the first barrier layer and the first multilayer film are joined, X expressed by the following Expression (1):

$$X ( \% ) = \{ A / ( B - C ) \} \times 100 \qquad Expression ( 1 )$$

is 35% or more,
where A (nm) represents a total thickness of dielectric layers included in the portion and having a QWOT of less than 2 and a refractive index of 1.9 or less when the layers included in the portion are evaluated by the QWOT expressed by the following Expression (2):

$$QWOT = ( thickness of target layer / 550 nm ) \times 4 \times refractive index at wavelength of 550 nm , \qquad Expression ( 2 )$$

B (nm) represents a total thickness of the portion, and
C (nm) represents a total thickness of layers having a QWOT of 2 or more in the portion.

### Aspect 3

The optical filter according to Aspect 1 or 2,
in which the optical filter has spectral characteristics in which, when light is incident from a side of the third multilayer film,
(II) a maximum reflectance Rₜ₁ₘₐₓ₁ in a wavelength range of from 450 nm to 950 nm is 20% or less at an incident angle θ=5°, and
(III) a maximum reflectance Rₜ₁ₘₐₓ₂ in a wavelength range of from 450 nm to 950 nm is 30% or less at an incident angle θ=60°.

### Aspect 4

The optical filter according to any one of Aspects 1 to 3,
in which the optical filter has spectral characteristics in which, when light is incident from the side of the second multilayer film,
(IV) an average transmittance Tₜ₍₂₎ₐᵥₑ₁ at a wavelength of from 440 nm to 500 nm is 80% or more at an incident angle θ=0°, and an average transmittance Tₜ₍₂₎ₐᵥₑ₂ at a wavelength of from 440 nm to 500 nm is 70% or more at an incident angle θ=60°,
(V) a wavelength λt₍ₜ₌₁₀₎₁ at which a transmittance is 10% is in a range of from 600 nm to 700 nm at an incident angle θ=0°,
(VI) a difference Δλₜ(absolute value) between a wavelength λₜ₍ₜ₌₁₀₎₂ at which a transmittance is 10% and λₜ₍ₜ₌₁₀₎₁ is 15 nm or less at an incident angle θ=60°, and
(VII) an average transmittance Tₜ₍₃₎ₐᵥₑ₁ at a wavelength of from 750 nm to 1,000 nm is 2% or less at an incident angle θ=0°, and an average transmittance Tₜ₍₃₎ₐᵥₑ₂ at a wavelength of from 750 nm to 1,000 nm is 2% or less at an incident angle θ=60°.

### Aspect 5

The optical filter according to any one of Aspects 1 to 4, in which the optical filter has spectral characteristics in which, when light is incident from the side of the second multilayer film,
(VIII) a maximum reflectance Rₜ₂ₘₐₓ₁ in a wavelength range of from 750 nm to 1,050 nm is 95% or more at an incident angle θ=5°, and
(IX) a maximum reflectance Rₜ₂ₘₐₓ₂ in a wavelength range of from 750 nm to 1,050 nm is 95% or more at an incident angle θ=60°.

### Aspect 6

The optical filter according to any one of Aspects 1 to 5,
in which the optical filter has spectral characteristics in which, when light is incident from the side of the second multilayer film,
(X) an average transmittance Tₜ₍₄₎ₐᵥₑ₁ at a wavelength of from 900 nm to 1,000 nm is 0.5% or less at an incident angle θ=0°.

### Aspect 7

The optical filter according to any one of Aspects 1 to 6, in which a total thickness of the first barrier layer and the first multilayer film is 1.0 m or more.

### Aspect 8

The optical filter according to any one of Aspects 1 to 7, in which at least one of the first barrier layer and the second barrier layer is made of an oxide of aluminum and/or an oxide of titanium.

### Aspect 9

The optical filter according to any one of Aspects 1 to 8,
in which the glass substrate contains, by mass %,
P⁵⁺: from 20% to 70%,
Al³⁺: from 1% to 20%,
K⁺: from 0% to 40%,
Li⁺: from 0% to 30%,
Na⁺: from 0% to 40%,
Rb⁺: from 0% to 20%,
Cs⁺: from 0% to 20%,
ΣR⁺ (R⁺ represents one or more components selected from Li⁺, Na⁺, Rb, and Cs⁺, and
ΣR⁺ represents a total amount of R)+K⁺: from 1% to 50%,
Mg²⁺: from 0% to 20%,
Ca²⁺: from 0% to 20%,
Sr²⁺: from 0% to 30%,
Ba²⁺: from 0% to 40%,
Cu²⁺: from 1% to 20%,
Zn²⁺: from 0% to 20%, and
ΣR″²⁺ (R″²⁺ represents one or more components selected from Ba²⁺, Sr²⁺, Ca²⁺, and Mg²⁺, and ΣR″²⁺ represents a total amount of R″²⁺): from 1% to 50%,
and contains from 3% to 60% of F⁻, expressed on an external ratio basis, and
the glass substrate has (i) a transmittance T_{g}(1200) of 25% or less at a wavelength of 1,200 nm
at an incident angle θ=0° when converted to a thickness of 0.2 mm.

### Aspect 10

The optical filter according to any one of Aspects 1 to 9, in which the glass substrate contains, by mass %,
P⁵⁺: from 20% to 70%,
Al³⁺: from 3.5% to 20%,
K⁺: from 1% to 40%,
Li⁺: from 0% to 30%,
Na⁺: from 0% to 40%,
Rb⁺: from 0% to 20%,
Cs⁺: from 0% to 20%,
ΣR⁺ (R⁺ represents one or more components selected from Li⁺, Na⁺, Rb⁺, and Cs⁺, and ΣR⁺ represents a total amount of R⁺)+K⁺: from 14% to 42%,
Mg²⁺: from 0% to 20%,
Ca²⁺: from 0% to 20%,
Sr²⁺: from 0% to 30%,
Ba²⁺: from 0% to 40%,
Cu²⁺: from 1% to 20%,
Zn²⁺: from 0% to 20%, and
ΣR″²⁺ (R″²⁺ represents one or more components selected from Ba²⁺, Sr²⁺, Ca²⁺, and Mg²⁺, and ΣR″²⁺ represents a total amount of R″²⁺): from 14% to 40%,
and contains from 3% to 60% of F⁻, expressed on an external ratio basis, and
the glass substrate has (i) a transmittance T_{g}(1200) of 25% or less at a wavelength of 1,200 nm
at an incident angle θ=0° when converted to a thickness of 0.2 mm.

### Aspect 11

The optical filter according to any one of Aspects 1 to 10,
in which, in the glass substrate,
P⁵⁺ content/ΣR′ (R′ represents one or more components selected from Al³⁺, Mg²⁺, and Li⁺, and ΣR′ represents a total amount of R′) is from 3.0 to 7.5 by mass %.

### Aspect 12

The optical filter according to any one of Aspects 1 to 11,
in which the glass substrate has spectral characteristics in which
(ii) a transmittance T_{g(420)} at a wavelength of 420 nm is 80% or more,
(iii) a transmittance T_{g(800)} at a wavelength of 800 nm is 6% or less, and
(iv) a wavelength λ_{g(t=50)1} at which a transmittance is 50% is in a range of from 600 nm to 670 nm
at an incident angle θ=0° when converted to a thickness of 0.2 mm.

### Aspect 13

The optical filter according to any one of Aspects 1 to 12,
in which, in the glass substrate, an expected value YA of an average ionic radius of alkali metal components expressed by the following Expression (4):

$${φ}_{A} ( pm ) = P / S \qquad Expression ( 4 )$$

is in a range of from 70 pm to 170 pm,
where P represents a value obtained by obtaining a result of ionic radius (pm)×cation amount for each alkali metal component contained in the glass substrate and adding up the results, and S represents a sum of the cation amounts of all of the alkali metal components.

### Aspect 14

A solid state image pickup device including: the optical filter according to any one of Aspects 1 to 13.

What is claimed is:

1. An optical filter comprising: a glass substrate,
wherein the glass substrate has a first main surface and a second main surface opposite to each other;
a first barrier layer, a first multilayer film, and a resin layer are disposed on the first main surface of the glass substrate in this order from the glass substrate side; a second barrier layer and a second multilayer film are disposed on the second main surface of the glass substrate in this order from the glass substrate side; a third multilayer film is disposed on the resin layer;
the glass substrate is fluorophosphate glass containing an infrared absorbent;
the first barrier layer and the second barrier layer each independently contain an oxide of at least one metal selected from the group consisting of aluminum (Al), titanium (Ti), niobium (Nb), tantalum (Ta), and hafnium (Hf) at a ratio of 80 mol % or more,
the resin layer contains a near infrared absorbing dye having a maximum absorption wavelength in a range of from 700 nm to 800 nm,
the first multilayer film, the second multilayer film, and the third multilayer film each independently include a plurality of dielectric layers, and
the optical filter has spectral characteristics in which
when light is incident from a side of the second multilayer film,
(I) an average transmittance Tₜ₍₁₎ₐᵥₑ₁ at a wavelength of from 900 nm to 1,200 nm is 5% or less at an incident angle θ=0°, and an average transmittance Tₜ₍₁₎ₐᵥₑ₂ at a wavelength of from 900 nm to 1,200 nm is 5% or less at an incident angle θ=60°.

2. The optical filter according to claim 1,
wherein, in a portion in which the first barrier layer and the first multilayer film are joined, X expressed by the following Expression (1):
$$X ( \% ) = \{ A / ( B - C ) \} \times 100 \qquad Expression ( 1 )$$
is 35% or more,
where A (nm) represents a total thickness of dielectric layers included in the portion and having a QWOT of less than 2 and a refractive index of 1.9 or less when the layers included in the portion are evaluated by the QWOT expressed by the following Expression (2):
$$QWOT = ( thickness of target layer / 550 nm ) \times 4 \times refractive index at wavelength of 550 nm , \qquad Expression ( 2 )$$
B (nm) represents a total thickness of the portion, and
C (nm) represents a total thickness of layers having a QWOT of 2 or more in the portion.

3. The optical filter according to claim 1,
wherein the optical filter has spectral characteristics in which, when light is incident from a side of the third multilayer film,
(II) a maximum reflectance Rₜ₁ₘₐₓ₁ in a wavelength range of from 450 nm to 950 nm is 20% or less at an incident angle θ=5°, and
(III) a maximum reflectance Rₜ₁ₘₐₓ₂ in a wavelength range of from 450 nm to 950 nm is 30% or less at an incident angle θ=60°.

4. The optical filter according to claim 1,
wherein the optical filter has spectral characteristics in which, when light is incident from the side of the second multilayer film,
(IV) an average transmittance Tₜ₍₂₎ₐᵥₑ₁ at a wavelength of from 440 nm to 500 nm is 80% or more at an incident angle θ=0°, and an average transmittance Tₜ₍₂₎ₐᵥₑ₂ at a wavelength of from 440 nm to a wavelength of 500 nm is 70% or more at an incident angle θ=60°,
(V) a wavelength λₜ₍ₜ₌₁₀₎₁ at which a transmittance is 10% is in a range of from 600 nm to 700 nm at an incident angle θ=0°,
(VI) a difference Δλₜ(absolute value) between a wavelength λₜ₍ₜ₌₁₀₎₂ at which a transmittance is 10% and λₜ₍ₜ₌₁₀₎₁ is 15 nm or less at an incident angle θ=60°, and
(VII) an average transmittance Tₜ₍₃₎ₐᵥₑ₁ at a wavelength of from 750 nm to 1,000 nm is 2% or less at an incident angle θ=0°, and an average transmittance Tₜ₍₃₎ₐᵥₑ₂ at a wavelength of from 750 nm to 1,000 nm is 2% or less at an incident angle θ=60°.

5. The optical filter according to claim 1,
wherein the optical filter has spectral characteristics in which, when light is incident from the side of the second multilayer film,
(VIII) a maximum reflectance Rₜ₂ₘₐₓ₁ in a wavelength range of from 750 nm to 1,050 nm is 95% or more at an incident angle θ=5°, and
(IX) a maximum reflectance Rₜ₂ₘₐₓ₂ in a wavelength range of from 750 nm to 1,050 nm is 95% or more at an incident angle θ=60°.

6. The optical filter according to claim 1,
wherein the optical filter has spectral characteristics in which, when light is incident from the side of the second multilayer film,
(X) an average transmittance Tₜ₍₄₎ₐᵥₑ₁ at a wavelength of from 900 nm to 1,000 nm is 0.5% or less at an incident angle θ=0°.

7. The optical filter according to claim 1, wherein a total thickness of the first barrier layer and the first multilayer film is 1.0 μm or more.

8. The optical filter according to claim 1, wherein at least one of the first barrier layer and the second barrier layer is made of an oxide of aluminum and/or an oxide of titanium.

9. The optical filter according to claim 1,
wherein the glass substrate contains, by mass %,
P⁵⁺: from 20% to 70%,
Al³⁺: from 1% to 20%,
K⁺: from 0% to 40%,
Li⁺: from 0% to 30%,
Na⁺: from 0% to 40%,
Rb⁺: from 0% to 20%,
Cs⁺: from 0% to 20%,
ΣR⁺ (R⁺ represents one or more components selected from Li⁺, Na⁺, Rb⁺, and Cs⁺, and ΣR⁺ represents a total amount of R⁺)+K⁺: from 1% to 50%,
Mg²⁺: from 0% to 20%,
Ca²⁺: from 0% to 20%,
Sr²⁺: from 0% to 30%,
Ba²⁺: from 0% to 40%,
Cu²⁺: from 1% to 20%,
Zn²⁺: from 0% to 20%, and
ΣR″²⁺ (R″²⁺ represents one or more components selected from Ba²⁺, Sr²⁺, Ca²⁺, and
Mg²⁺, and ΣR″²⁺ represents a total amount of R″²⁺): from 1% to 50%,
and contains from 3% to 60% of F⁻, expressed on an external ratio basis, and
the glass substrate has (i) a transmittance T_{g(1200)} of 25% or less at a wavelength of 1,200 nm
at an incident angle θ=0° when converted to a thickness of 0.2 mm.

10. The optical filter according to claim 1,
wherein the glass substrate contains, by mass %,
P⁵⁺: from 20% to 70%,
Al³⁺: from 3.5% to 20%,
K⁺: from 1% to 40%,
Li⁺: from 0% to 30%,
Na⁺: from 0% to 40%,
Rb⁺: from 0% to 20%,
Cs⁺: from 0% to 20%,
ΣR⁺ (R⁺ represents one or more components selected from Li⁺, Na⁺, Rb⁺, and Cs⁺, and
ΣR⁺ represents a total amount of R⁺)+K⁺: from 14% to 42%,
Mg²⁺: from 0% to 20%,
Ca²⁺: from 0% to 20%,
Sr²⁺: from 0% to 30%,
Ba²⁺: from 0% to 40%,
Cu²⁺: from 1% to 20%,
Zn²⁺: from 0% to 20%, and
ΣR″²⁺ (R″²⁺ represents one or more components selected from Ba²⁺, Sr²⁺, Ca²⁺, and Mg²⁺, and ΣR″²⁺ represents a total amount of R″²⁺): from 14% to 40%,
and contains from 3% to 60% of F⁻, expressed on an external ratio basis, and
the glass substrate has (i) a transmittance T_{g(1200)} of 25% or less at a wavelength of 1,200 nm
at an incident angle θ=0° when converted to a thickness of 0.2 mm.

11. The optical filter according to claim 9,
wherein, in the glass substrate,
P⁵⁺ content/ΣR′ (R′ represents one or more components selected from Al³⁺, Mg²⁺, and Li⁺, and ΣR′ represents a total amount of R′) is from 3.0 to 7.5 by mass %.

12. The optical filter according to claim 9,
wherein the glass substrate has spectral characteristics in which
(ii) a transmittance T_{g(420)} at a wavelength of 420 nm is 80% or more,
(iii) a transmittance T_{g(800)} at a wavelength of 800 nm is 6% or less, and
(iv) a wavelength λ_{g(t=50)1} at which a transmittance is 50% is in a range of from 600 nm to 670 nm
at an incident angle θ=0° when converted to a thickness of 0.2 mm.

13. The optical filter according to claim 10,
wherein, in the glass substrate, an expected value φ_{A} of an average ionic radius of alkali metal components expressed by the following Expression (4):
$${φ}_{A} ( pm ) = P / S \qquad Expression ( 4 )$$
is in a range of from 70 μm to 170 μm,
where P represents a value obtained by obtaining a result of ionic radius (pm)×cation amount for each alkali metal component contained in the glass substrate and adding up the results, and S represents a sum of the cation amounts of all of the alkali metal components.

14. A solid state image pickup device comprising: the optical filter according to claim 1.
